(19) United States
(12) Patent Application Publication
(10) Pub. No.: US 2025/0106748 A1
(43) Pub. Date: Mar. 27, 2025

(54) MANAGING TRUSTED WLAN INTERWORKING FUNCTION (TWIF) OPERATION IN WIRELESS NETWORK

(71) Applicant: SAMSUNG ELECTRONICS CO,.LTD., Suwon-si (KR)

(72) Inventors: Murali REDDIBOYANA, Bangalore (IN); Mustque Ahmed, Bangalore (IN); Vasanth Diagarassin, Bangalore (IN)

(21) Appl. No.: 18/670,176

(22) Filed: May 21, 2024

Related U.S. Application Data
(63) Continuation of application No. PCT/KR2024/005793, filed on Apr. 29, 2024.

(30) Foreign Application Priority Data
Sep. 21, 2023 (IN) 202341063555

(51) Int. Cl. H04W 48/18; H04W 76/30; H04W 80/06; H04W 84/12

(52) U.S. Cl. CPC H04W 48/18; H04W 76/30; H04W 80/06; H04W 84/12

(57) ABSTRACT

A method is provided. The method performed by a trusted wireless local area network (WLAN) Interworking Function (TWIF) control plane (TWIF-C) entity in a trusted WLAN access network, comprises communicating with a TWIF user plane (TWIF-U) entity through a E13 interface. Each of the TWIF-C entity and the TWIF-U entity is communicated with a trusted WLAN access point (TWAP) in the trusted WLAN access network connected to a user equipment (UE).

### CROSS-REFERENCE TO RELATED APPLICATIONS

This application is a continuation of International Application No. PCT/KR2024/005793 designating the United States, filed on Apr. 29, 2024, in the Korean Intellectual Property Receiving Office and claiming priority to Indian Patent Application number 202341063555, filed on Sep. 21, 2023, in the Indian Patent Office, the disclosures of each of which are incorporated by reference herein in their entireties.

### BACKGROUND

### Field

The present disclosure relates to the field of wireless networks, and for example, to methods and the wireless network for managing a Trusted WLAN Interworking Function (TWIF) operation.

### Description of Related Art

A Control and User Plane Separation (CUPS) architecture is heavily adopted in a fourth generation (4G) core network/a fifth generation (5G) core network. The CUPS architecture is even adopted in an gNB in the 5G core network between an gNB central unit control plane (gNB-CU-CP) and a gNB central unit user plane (gNB-CU-UP). However, the CUPS architecture is not yet adopted in a Trusted WLAN Interworking Function (TWIF). As per a latest 3GPP standard, the TWIF is still monolithic. In other words, the TWIF has similar role of the gNB in a 5G network. The TWIF and the gNB have a N2 interface towards an Access and Mobility Management Function (AMF) entity and a N3 towards a User Plane Function (UPF). The gNB is split into the gNB-CU-CP and the gNB-CU-UP. A 3GPP E1 interface is used between the gNB-CU-CP and the gNB-CU-UP. However, the TWIF is still single network element. It is very important to have the CUPS architecture on the TWIF. A new 3GPP interface (E13) is required between a TWIF-C entity and a TWIF-U entity.

It is desired to address the above mentioned disadvantages or other shortcomings or at least provide a useful alternative.

### SUMMARY

Embodiments of the disclosure provide methods and a wireless network for managing a Trusted WLAN Interworking Function (TWIF) operation in the wireless network.

Embodiments of the disclosure provide Control and User Plane Separation (CUPS) on a TWIF by splitting the TWIF into a TWIF-C entity and a TWIF-U entity.

Embodiments of the disclosure may split the TWIF into the TWIF-C entity and the TWIF-U entity and introduce an interface (e.g. E13 interface) between the TWIF-C entity and TWIF-U entity.

Embodiments of the disclosure provide an interface (e.g., E13 interface or the like) having an E13 Application Protocol (E13AP) protocol running on a transport protocol (e.g., Stream Control Transmission Protocol (SCTP), Transmission Control Protocol (TCP), User Datagram Protocol (UDP) or the like). The E13 interface may make use of benefits that come from the transport protocol (e.g., SCTP, TCP, UDP, or the like) and also E13AP (e.g., light-weight protocol). In disclosed methods, the E13AP supports necessary interface management, bearer management, and other procedures in 3GPP standards. The E13 AP is more suitable for an access node like TWIF. The E13AP obtains very well with the NGAP.

Accordingly, example embodiments herein disclose a method for managing a TWIF operation in a wireless network. The method includes splitting a TWIF function as a TWIF-C entity and a TWIF-U entity. Further, the method includes handling a control plane signalling by the TWIF-C entity and a user plane signalling by the TWIF-U entity.

In an embodiment, the method includes creating an E13 interface between the TWIF-C entity and the TWIF-U entity.

Accordingly, example embodiments herein disclose methods for managing a Trusted WLAN Interworking Function (TWIF) operation in a wireless network. The method includes splitting a functionality of a TWIF into a control plane functionality and a user plane functionality. The control plane functionality is handled by a TWIF Control plane (TWIF-C) entity and the user plane functionality is handled by at least one TWIF User plane (TWIF-U) entity. The TWIF-C entity and the at least one TWIF-U entity support an interface (e.g., E13 interface).

Accordingly, example embodiments herein disclose a TWIF-U entity including an interface controller coupled with a processor and a memory. The interface controller is configured to support a user plane functionality, where the user plane functionality is handled by the TWIF-U entity. Further, the interface controller is configured to add an interface between a TWIF-C entity and the TWIF-U entity. Further, the interface controller is configured to monitor at least one of an operation associated with the interface and a service associated with the interface.

Accordingly, example embodiments herein disclose a TWIF-C entity including an interface controller coupled with a processor and a memory. The interface controller is configured to support a control plane functionality. The control plane functionality is handled by the TWIF-C entity. Further, the interface controller is configured to add an interface between the TWIF-C entity and at least one TWIF-U entity. Further, the interface controller is configured to monitor at least one of an operation associated with the interface and a service associated with the interface.

In an example embodiment, the method includes monitoring at least one of an operation associated with the interface and a service associated with the interface.

In an example embodiment, the interface includes an E13 interface, where the TWIF-C entity receives at least one control plan message from a User Equipment (UE) and where the TWIF-U entity receives at least one user plan message from the UE.

In an example embodiment, the operation includes at least one of an user plane traffic procedure, an interface management procedure, a bearer management procedure, a trace start procedure, a deactivate trace procedure, and a load management procedure. The service includes at least one of a UE-associated service and a non UE-associated service.

In an example embodiment, the interface management procedure includes at least one of a reset procedure initiated from the TWIF-C entity, a reset procedure initiated from the at least one TWIF-U entity, an error indication procedure originated at the TWIF-C entity, an error indication procedure originated at the at least one TWIF-U entity, a TWIF-U E13 setup procedure, a TWIF-C E13 setup procedure, a TWIF-U configuration update procedure, a TWIF-C configuration update procedure, an E13 release procedure, and a TWIF-U status indication procedure.

In an example embodiment, during the reset procedure initiated from the TWIF-C entity, the TWIF-C entity sends a reset message to the at least one TWIF-U entity. The reset message includes at least one of: a message type, a transaction ID, a cause, a choice reset type, a E13 interface, a reset all, a part of E13 interface, a UE-associated logical E13-connection list, a UE-associated logical E13-connection item, TWIF-C UE E13AP ID, and a TWIF-U UE E13AP ID. The TWIF-C entity receives a reset acknowledgement message from the TWIF-U entity based on the reset message. The reset acknowledgement message includes at least one of a message type, a transaction ID, a UE-associated logical E13-connection list, a UE-associated logical E13-connection item, TWIF-C UE E13AP ID, TWIF-U UE E13AP ID and criticality diagnostics.

In an example embodiment, during the reset procedure initiated from the at least one TWIF-U entity, the at least one TWIF-U entity sends a reset message to the TWIF-C entity. The at least one TWIF-U entity receives a reset acknowledgement message from the TWIF-C entity based on the reset message.

In an example embodiment, during the error indication procedure originated at the TWIF-C entity, where the TWIF-C entity sends an error indication message to the at least one TWIF-U entity. The error indication message includes at least one of: a message type, a transaction ID, a TWIF-C UE E13AP ID, a TWIF-U UE E13AP ID, cause, and criticality diagnostics.

In an example embodiment, during the error indication procedure originated at the at least one TWIF-U entity. The at least one TWIF-U entity sends an error indication message to TWIF-C entity.

In an example embodiment, during the TWIF-U E13 setup procedure, the at least one TWIF-U entity sends a TWIF-U E13 setup request message to the TWIF-C entity. The TWIF-U E13 setup request message includes at least one of: a message type, a transaction ID, a TWIF-U ID, a TWIF-U name, a core network (CN) support, a PLMN Identity, a slice support list, an extended slice support list, a Quality of service (QOS) parameters support list, a TWIF-U capacity, a transport network layer address and an extended TWIF-U name. The at least one TWIF-U entity receives one of a TWIF-U E13 setup response message and a TWIF-U E13 setup failure response message from the TWIF-C entity based on the TWIF-U E13 setup request message. The TWIF-U E13 setup response message includes at least one of a message type, a transaction ID, a TWIF-C name, a transport network layer address information, an extended TWIF-C name and a criticality diagnostics and where the TWIF-U E13 setup failure response message includes at least one of: a message type, a transaction ID, a cause, a time to wait and criticality diagnostics.

In an example embodiment, during the TWIF-C E13 setup procedure, the TWIF-C entity sends a TWIF-C E13 setup request message to the at least one TWIF-U entity. The TWIF-C E13 setup request message includes at least one of: a message type, a transaction ID, a TWIF-C name, a transport network layer address information and an extended TWIF-C name. The TWIF-C entity receives one of a TWIF-C E13 setup response and a TWIF-C E13 setup failure response from the at least one TWIF-U entity based on the TWIF-C E13 setup request message. The TWIF-C E13 setup response includes at least one of: a message type, a transaction ID, a TWIF-U ID, a TWIF-U name, a CN Support, a PLMN identity, a slice support list, an extended slice support list, a QoS parameters support list, a TWIF-U capacity, a transport network layer address information, an extended TWIF-U name, and criticality diagnostics. The TWIF-C E13 setup failure response includes at least one of: a message type, a transaction ID, a cause, a time to wait and criticality diagnostics.

In an example embodiment, during the TWIF-U configuration update procedure, the at least one TWIF-U entity sends a TWIF-U configuration update procedure message to the TWIF-C entity. The TWIF-U configuration update procedure message includes at least one of: a message type, a transaction ID, a TWIF-U ID, a TWIF-U name, a PLMN Identity, a slice support list, an extended slice support list, a QoS parameters support list, a TWIF-U capacity, a TWIF-U TNLA to remove list, a transport network layer address information and an extended TWIF-U name. The at least one TWIF-U entity receives one of a TWIF-U configuration update acknowledge message and a TWIF-U configuration update failure message from the TWIF-C entity based on the TWIF-U configuration update procedure message. The TWIF-U configuration update acknowledge message includes at least one of: a message type, a transaction ID, criticality diagnostics, and transport network layer address information, and where the TWIF-U configuration update failure message includes at least one of: a message type, a transaction ID, cause, time to wait and criticality diagnostics.

In an example embodiment, during the TWIF-C configuration update procedure, the TWIF-C entity sends a TWIF-C configuration update procedure message to the at least one TWIF-U entity. The TWIF-C configuration update procedure message includes at least one of a message Type, a transaction ID, a TWIF-U ID, a TWIF-U Name, a PLMN Identity, a slice support list, an extended slice support list, a QoS parameters support list, a TWIF-U capacity, TWIF-U TNLA To Remove Item IEs, a TNLA transport layer address, a TNLA transport layer address TWIF-C, transport network layer address information and an extended TWIF-U name. The TWIF-C entity receives one of a TWIF-C configuration update acknowledge message and a TWIF-C configuration update failure message from the at least one TWIF-U entity based on the TWIF-C configuration update procedure message. The TWIF-C configuration update acknowledge message includes at least one of: a message type, a transaction ID, criticality diagnostics, and transport network layer address information. The TWIF-C configuration update failure message includes at least one of message having at least one of: a message type, a transaction ID, cause, time to wait and criticality diagnostics.

In an example embodiment, during the E13 release procedure originated at the TWIF-C entity, the TWIF-C entity sends a E13 release request message to the at least one TWIF-U entity. The E13 release request message includes at least one of: a message type, a transaction ID and cause. The TWIF-C entity receives a E13 release response message from the at least one TWIF-U entity based on the E13 release request message. The E13 release response message includes at least one of: a message type, a transaction ID and criticality diagnostics.

In an example embodiment, during the E13 release procedure originated at the at least one TWIF-U entity, the at least one TWIF-U entity sends a E13 release request message to the TWIF-C entity, where the E13 release request message includes at least one of a message type, a transaction ID and cause. The at least one TWIF-U entity receives a E13 release response message from the TWIF-C entity based on the E13 release request message. The E13 release response message includes at least one of a message type, a transaction ID and criticality diagnostics.

In an example embodiment, during the TWIF-U status indication procedure, the at least one TWIF-U entity sends a TWIF-U status indication message to the TWIF-C. The TWIF-U status indication message includes at least one of a message type, a transaction ID, and a TWIF-U overload information.

In an example embodiment, the bearer management procedure includes at least one of a bearer context setup procedure, a bearer context release request procedure initiated by the at least one TWIF-U entity, a bearer context release procedure initiated by the TWIF-C entity, a bearer context modification procedure initiated by the TWIF-C entity, a bearer context modification required procedure initiated by the at least one TWIF-U entity, a bearer context inactivity notification procedure, a data usage report procedure, a DL data notification procedure, and an UL data notification procedure.

In an example embodiment, during the bearer context setup procedure, a bearer context setup request message is sent by the TWIF-C entity to request the at least one TWIF-U entity to setup a bearer context. The bearer context setup response message is sent by the at least one TWIF-U entity to confirm the setup of the requested bearer context.

In an example embodiment, during the bearer context release request procedure initiated by the at least one TWIF-U entity, the TWIF-U entity sends a bearer context release request message to the TWIF-C entity. The bearer context release request message includes at least one of: a message type, a TWIF-C UE E13AP ID, a TWIF-U UE E13AP ID and a cause.

In an example embodiment, during the bearer context release procedure initiated by the TWIF-C entity, the TWIF-C entity sends a bearer context release command message to the at least one TWIF-U entity) and the TWIF-C entity receives a bearer context release complete message from the at least one TWIF-U entity based on the bearer context release command message. The bearer context release command includes at least one of: a message type, a TWIF-C UE E13AP ID, a TWIF-U UE E13AP ID and a cause. The bearer context release complete message includes at least one of: a message type, a TWIF-C UE E13AP ID, a TWIF-U UE E13AP ID, criticality diagnostics and retainability measurements information.

In an example embodiment, during the bearer context modification procedure initiated by the TWIF-C entity, the TWIF-C entity sends a bearer context modification request message to the at least one TWIF-U entity. The TWIF-C entity receives one of a bearer context modification response or a bearer context modification failure from the at least one TWIF-U entity based on the bearer context modification request message.

In an example embodiment, during the bearer context modification required procedure initiated by the at least one TWIF-U entity, the at least one TWIF-U entity sends a bearer context modification request message to the TWIF-C entity. The at least one TWIF-U entity receives one of a bearer context modification response or a bearer context modification failure from the TWIF-C entity based on the bearer context modification request message.

In an example embodiment, during the bearer context inactivity notification procedure, the at least one TWIF-U entity sends a bearer context inactivity notification message to the TWIF-C entity. The bearer context inactivity notification message includes at least one of: a message type, a TWIF-C UE E13AP ID, a TWIF-U UE E13AP ID, a choice activity information, a PDU session resource activity list, a PDU session resource activity item, and a UE activity.

In an example embodiment, during the data usage report procedure, the at least one TWIF-U entity sends a data usage report message to the TWIF-C entity. The data usage report message includes at least one of: a message type, a TWIF-C UE E13AP ID, a TWIF-U UE E13AP ID, and a data usage report list.

In an example embodiment, during the the DL data notification procedure, the at least one TWIF-U entity sends a DL data notification message to the TWIF-C entity. The DL data notification message includes at least one of: a message type, a TWIF-C UE E13AP ID, a TWIF-U UE E13AP ID, a Paging Priority Indicator (PPI), a PDU Session To Notify List, a PDU session to notify item and a PDU session ID.

In an example embodiment, during the UL data notification procedure, the at least one TWIF-U entity sends a UL data notification message to the TWIF-C entity. The UL data notification message includes at least one of: a message type, a TWIF-C UE E13AP ID, a TWIF-U UE E13AP ID, a PDU Session To Notify List, a PDU session to notify item and a PDU session ID.

In an example embodiment, the load management procedure includes at least one of a resource status reporting initiation procedure and a resource status reporting procedure.

In an example embodiment, during the resource status reporting initiation procedure, the at least one TWIF-U entity sends a resource status request message to the TWIF-C entity. The resource status request message includes at least one of: a message type, a transaction ID, a TWIF-C measurement ID, a TWIF-U measurement ID, a registration request, a report characteristics and a reporting periodicity. The at least one TWIF-U entity receives at least one of: a resource status response message and resource status failure message from the TWIF-C entity based on the resource status request message. The resource status response message includes at least one of: a message type, a transaction ID, a TWIF-C measurement ID, a TWIF-U measurement ID, and criticality diagnostics, and where the resource status failure message includes at least one of: a message type, a transaction ID, a TWIF-C measurement ID, a TWIF-U measurement ID, cause, and criticality diagnostics.

In an example embodiment, during the resource status reporting procedure, the at least one TWIF-U entity sends a resource status update message to the TWIF-C entity. The resource status update message includes at least one of: a message type, a transaction ID, a TWIF-C measurement ID, a TWIF-U measurement ID, a TNL available capacity indicator and a hardware capacity indicator.

In an example embodiment, the interface includes an E13 AP, where the E13AP is specific to the TWIF and runs on a Stream Control Transmission Protocol (SCTP). The E13AP supports at least one of a UE-associated service and a non UE-associated service.

In an example embodiment, the at least one control plane functionality from a UE towards a core network passes through the TWIF-C entity, where the at least one user plane functionality passes from the UE towards a data network through the at least one TWIF-U entity.

In an example embodiment, the TWIF-C entity is configured to select the at least one TWIF-U entity during a protocol data unit (PDU) session establishment procedure based on a local selection procedure.

In an example embodiment, the TWIF-C is configured to move a UE context from one TWIF-U to another TWIF-U during at least one failure scenario.

In an example embodiment, the at least one failure scenario includes at least one of a TWIF-U E13 setup failure, a TWIF-C E13 setup failure, a TWIF-U configuration update failure, a TWIF-C configuration update failure, a bearer context setup failure, a bearer context modification failure, and a resource status reporting initiation failure.

In embodiments of the disclosure, a method performed by a trusted wireless local area network (WLAN) Interworking Function (TWIF) control plane (TWIF-C) entity in a trusted WLAN access network, may comprise communicating with a TWIF user plane (TWIF-U) entity through a E13 interface. Each of the TWIF-C entity and the TWIF-U entity may be communicated with a trusted WLAN access point (TWAP) in the trusted WLAN access network connected to a user equipment (UE).

In embodiments of the disclosure, a method performed by a trusted wireless local area network (WLAN) Interworking Function (TWIF) user plane (TWIF-U) entity in a trusted WLAN access network, may comprise communicating with a TWIF control plane (TWIF-C) entity through a E13 interface. Each of the TWIF-C entity and the TWIF-U entity may be communicated with a trusted WLAN access point (TWAP) in the trusted WLAN access network connected to a user equipment (UE).

In embodiments of the disclosure, a TWIF Control plane (TWIF-C) entity may comprise at least one processor. The TWIF-C entity may comprise memory storing instructions. The instructions, when executed by the at least one processor, may cause the TWIF-C entity to communicate with a TWIF user plane (TWIF-U) entity through a E13 interface. Each of the TWIF-C entity and the TWIF-U entity may be communicated with a trusted WLAN access point (TWAP) in the trusted WLAN access network connected to a user equipment (UE).

In embodiments of the disclosure, a non-transitory computer readable storage medium, when individually or collectively executed by at least one processor of a TWIF Control plane (TWIF-C) entity, may store one or more computer programs including instructions that cause the TWIF-C entity to communicate with a TWIF user plane (TWIF-U) entity through a E13 interface. Each of the TWIF-C entity and the TWIF-U entity may be communicated with a trusted WLAN access point (TWAP) in the trusted WLAN access network connected to a user equipment (UE).

In embodiments of the disclosure, a TWIF user plane (TWIF-U) entity may comprise at least one processor. The TWIF-U entity may comprise memory storing instructions. The instructions, when executed by the at least one processor, may cause the TWIF-U entity to communicate with a TWIF control plane (TWIF-C) entity through a E13 interface. Each of the TWIF-C entity and the TWIF-U entity may be communicated with a trusted WLAN access point (TWAP) in the trusted WLAN access network connected to a user equipment (UE).

In embodiments of the disclosure, a non-transitory computer readable storage medium, when individually or collectively executed by at least one processor of a TWIF user plane (TWIF-U) entity, may store one or more computer programs including instructions that cause the TWIF-U entity to communicate with a TWIF control plane (TWIF-C) entity through a E13 interface. Each of the TWIF-C entity and the TWIF-U entity may be communicated with a trusted WLAN access point (TWAP) in the trusted WLAN access network connected to a user equipment (UE).

These and other aspects of the various example embodiments herein will be better appreciated and understood when considered in conjunction with the following description and the accompanying drawings. It should be understood, however, that the following descriptions, while indicating various example embodiments and numerous specific details thereof, are given by way of illustration and not of limitation. Many changes and modifications may be made within the scope of the example embodiments herein without departing from the scope thereof, and the example embodiments herein include all such modifications.

### BRIEF DESCRIPTION OF THE DRAWINGS

Embodiments herein are illustrated in the accompanying drawings, throughout which like reference letters indicate corresponding parts in the various figures. The above and other aspects, features and advantages of certain embodiments of the present disclosure will be more apparent from the following detailed description, taken in conjunction with the accompanying drawings, in which:

FIG. 1 is a diagram illustrating a TWIF CUPS architecture, according to various embodiments;

FIG. 2 is a diagram illustrating example signalling for a user plane establishment, according to various embodiments;

FIG. 3 is a diagram illustrating an E13 interface protocol structure, according to various embodiments;

FIG. 4 is a diagram illustrating a control plane connection, according to various embodiments;

FIG. 5 is a diagram illustrating a user plane connectivity and a user plane terminating at a TWIF-U entity, according to various embodiments;

FIG. 6 is a signal flow diagram illustrating an example reset procedure initiated from a TWIF-C entity, according to various embodiments;

FIG. 7 is a signal flow diagram illustrating an example reset procedure initiated from a TWIF-U entity, according to various embodiments;

FIG. 8 is a signal flow diagram illustrating an example error indication procedure originated at the TWIF-C entity, according to various embodiments;

FIG. 9 is a signal flow diagram illustrating an example error indication procedure originated at the TWIF-U entity, according to various embodiments;

FIG. 10 is a signal flow diagram illustrating an example TWIF-U E13 setup procedure during a success scenario, according to various embodiments;

FIG. 11 is a signal flow diagram illustrating an example TWIF-U E13 setup procedure during a failure scenario, according to various embodiments;

FIG. 12 is a signal flow diagram illustrating an example TWIF-C E13 setup procedure during a success scenario, according to various embodiments;

FIG. 13 is a signal flow diagram illustrating an example TWIF-C E13 setup procedure during a failure scenario, according to various embodiments;

FIG. 14 is a signal flow diagram illustrating an example TWIF-U configuration update procedure during a success scenario, according to various embodiments;

FIG. 15 is a signal flow diagram illustrating an example TWIF-U configuration update procedure during a failure scenario, according to various embodiments;

FIG. 16 is a signal flow diagram illustrating an example TWIF-C configuration update procedure during a success scenario, according to various embodiments;

FIG. 17 is a signal flow diagram illustrating an example TWIF-C configuration update procedure during a failure scenario, according to various embodiments;

FIG. 18 is a signal flow diagram illustrating an example E13 release procedure initiated from the TWIF-C entity, according to various embodiments;

FIG. 19 is a signal flow diagram illustrating an example E13 release procedure initiated from the TWIF-U entity, according to various embodiments;

FIG. 20 is a signal flow diagram illustrating an example TWIF-U status indication procedure, according to various embodiments;

FIG. 21 is a signal flow diagram illustrating example resource status reporting initiation during a success scenario, according to various embodiments;

FIG. 22 is a signal flow diagram illustrating an example resource status reporting initiation during a failure scenario, according to various embodiments;

FIG. 23 is a signal flow diagram illustrating an example resource status reporting during a success scenario, according to various embodiments;

FIG. 24 is a signal flow diagram illustrating an example bearer context setup procedure during a success scenario, according to various embodiments;

FIG. 25 is a signal flow diagram illustrating an example bearer context setup procedure during a failure scenario, according to various embodiments;

FIG. 26 is a signal flow diagram illustrating an example bearer context modification procedure during a success scenario, according to various embodiments;

FIG. 27 is a signal flow diagram illustrating an example bearer context modification procedure during a failure scenario, according to various embodiments;

FIG. 28 is a signal flow diagram illustrating an example bearer context modification required procedure during a success scenario, according to various embodiments;

FIG. 29 is a signal flow diagram illustrating an example bearer context release procedure, according to various embodiments;

FIG. 30 is a signal flow diagram illustrating an example bearer context release request procedure, according to various embodiments;

FIG. 31 is a signal flow diagram illustrating an example bearer context inactivity notification procedure, according to various embodiments;

FIG. 32 is a signal flow diagram illustrating an example DL data notification procedure, according to various embodiments;

FIG. 33 is a signal flow diagram illustrating an example data usage report procedure, according to various embodiments;

FIG. 34 is a signal flow diagram illustrating an example UL data notification procedure, according to various embodiments;

FIG. 35 is a signal flow diagram illustrating an example trace start procedure, according to various embodiments;

FIG. 36 is a signal flow diagram illustrating an example deactivate trace procedure, according to various embodiments;

FIG. 37 is a block diagram illustrating an example configuration of an wireless network, according to various embodiments; and

FIG. 38 is a flowchart illustrating an example method for managing a Trusted WLAN Interworking Function (TWIF) operation in a wireless network, according to various embodiments.

### DETAILED DESCRIPTION

The various example embodiments herein and the various features and advantageous details thereof are explained more fully with reference to the non-limiting embodiments that are illustrated in the accompanying drawings and detailed in the following description. Descriptions of well-known components and processing techniques may be omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

The embodiments herein disclose methods for managing a TWIF operation in a wireless network. The method includes configuring a TWIF function as a TWIF-C entity and a TWIF-U entity. Further, the method includes handling a control plane signalling by the TWIF-C entity and a user plane signalling by the TWIF-U entity.

Unlike conventional methods and systems, the disclosed method can be used to introduce the CUPS on the TWIF by splitting the TWIF into the TWIF-C entity and the TWIF-U entity and by introducing an interface (e.g., E13 interface) between the TWIF-C entity and the TWIF-U entity.

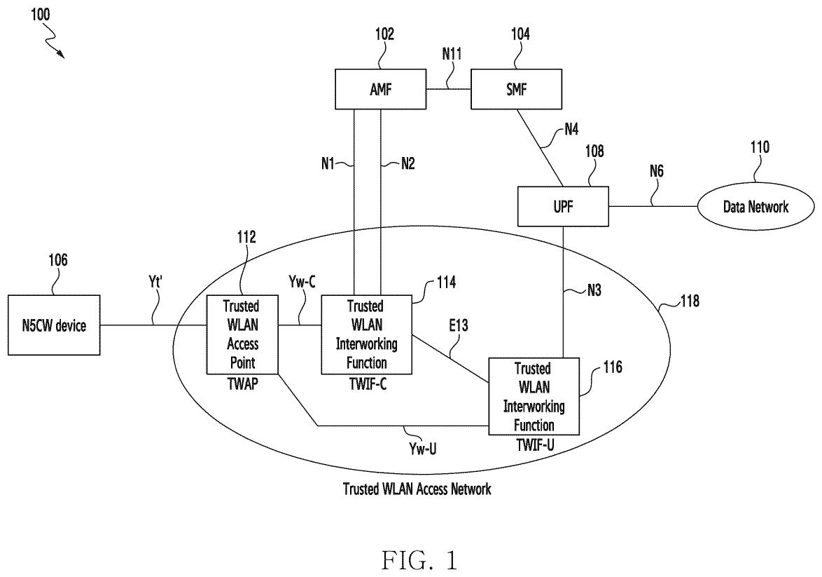

Referring now to the drawings, and more particularly to FIGS. 1 through 38, where similar reference characters denote corresponding features consistently throughout the figures, there are shown various example embodiments.

FIG. 1 is a diagram illustrating a control and user plane separation architecture in a wireless network (100), according to various embodiments. In an embodiment, the wireless network (100) includes an AMF (102), a SMF (104), a non-5G-capable over WLAN (N5CW) device (106), a UPF (108), a data network (110), a trusted WLAN access point (112), a TWIF-C entity (114), a TWIF-U entity (116) and a trusted WLAN access network (118). The operations and functions of the AMF (102), the SMF (104), the N5CW device (106), the UPF (108), the data network (110), the trusted WLAN access point (112), and the trusted WLAN access network (118) are defined in the 3GPP TS 23.501 and 3GPP TS 23.502, which are incorporated by reference herein in their entireties. For the sake of brevity, descriptions of the same operations are not repeated here. An N11 interface is used between the AMF (102) and the SMF (104). An N4 interface is used between the SMF (104) and the UPF (108). An N6 interface is used between the UPF (108) and the data network (110).

The trusted WLAN access point (112), the TWIF-C entity (114), the TWIF-U entity (116) are operated in the trusted WLAN access network (118). The TWIF-C entity (114) is communicated with the AMF (102) through a N1 interface and a N2 interface. The TWIF-C entity (114) is communicated with the TWIF-U entity (116) through a E13 interface, where the TWIF-U entity (116) is communicated with the trusted WLAN access point (112) through a Y_{W}-U interface. The trusted WLAN access point (112) is communicated with the TWIF-C entity (114) through a Y_{W}-C interface. The trusted WLAN access point (112) is communicated with the N5CW device (106) through Yt′ interface. The N5CW device (106) is referred to as a UE (user equipment). The N5CW device (106) does not support 5GC NAS signalling over WLAN access. The N5CW device (106) is not capable to operate as a 5G UE that supports 5GC NAS signalling over a WLAN access network, however, the N5CW device (106) may be capable to operate as a 5G UE over NG-RAN.

In an embodiment, TWIF is divided into the TWIF-C entity (114) and the TWIF-U entity (116). All the control plane signalling is handled by the TWIF-C entity (114) and the user plane signalling is handled by the TWIF-U entity (116). The E13 interface is introduced between the TWIF-C entity (114) and the TWIF-U entity (116). An N2 interface is used between the AMF (102) and the TWIF-C entity (114). An N3 interface is used between the UPF (108) and the TWIF-U entity (116). All the control plane signalling from a UE (not shown) towards a core network (not shown) goes via the TWIF-C entity (114). All the user plane data goes from the UE towards the data network (110) goes via the TWIF-U entity (116).

The TWIF-C entity (114) selects the at least one TWIF-U entity (116) during a protocol data unit (PDU) session establishment procedure based on a local selection procedure. The local selection procedure is a round-robin procedure or based on the resource status received from TWIF-U(s) (116).

Further, the TWIF-C (114) moves a UE context from one TWIF-U to another TWIF-U during at least one failure scenario. The failure scenario can be, for example, but not limited to a TWIF-U E13 setup failure, a TWIF-C E13 setup failure, a TWIF-U configuration update failure, a TWIF-C configuration update failure, a bearer context setup failure, a bearer context modification failure, and a resource status reporting initiation failure.

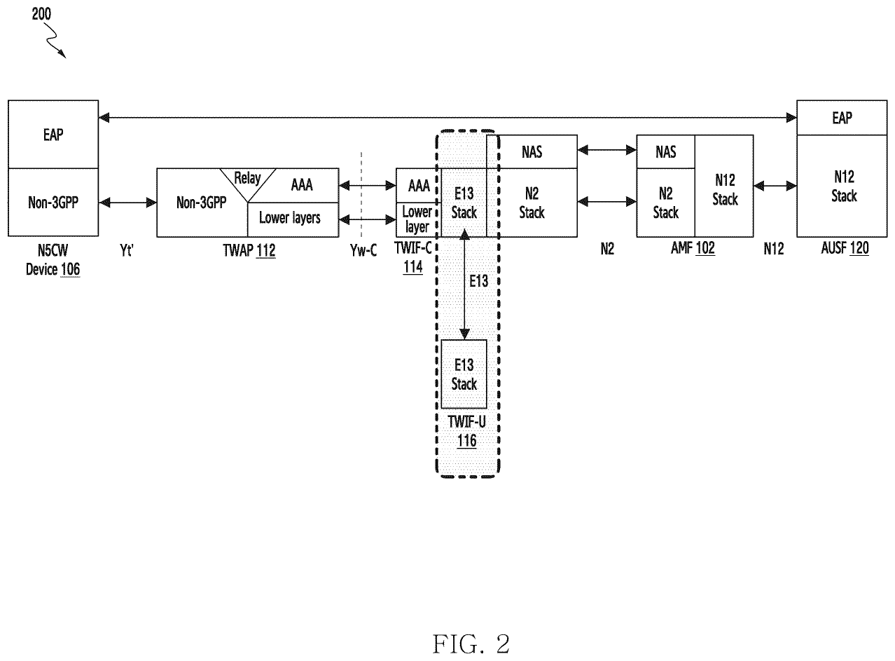

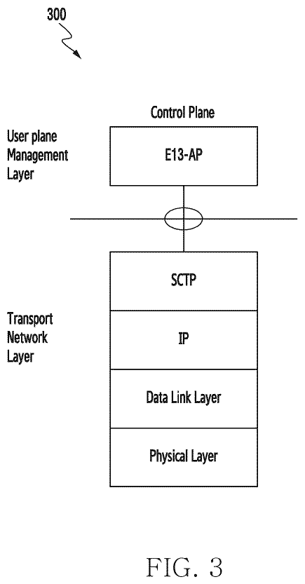

FIG. 2 is a diagram illustrating signalling (200) for a user plane establishment, according to various embodiments. For example, the AMF (102) is communicated with AUSF (120) through an N12 interface related to an N12 stack. FIG. 3 is a diagram illustrating an E13 interface protocol structure (300), according to various embodiments. The TWIF-C entity (114) and the TWIF-U entity (116) runs on the E13 stack. The E13 interface has an E13AP (E13 Application Protocol) that runs on top of a SCTP (Stream Control Transmission Protocol). In an embodiment, the E13 interface has the E13AP that runs on other transport protocols such as Transmission Control Protocol (TCP), User Datagram Protocol (UDP) or the like. The E13AP handles UE-associated services and non UE-associated services. The non UE-associated service is well defined standard 3GPP procedures. The E13AP supports interface management, bearer management, and other necessary features.

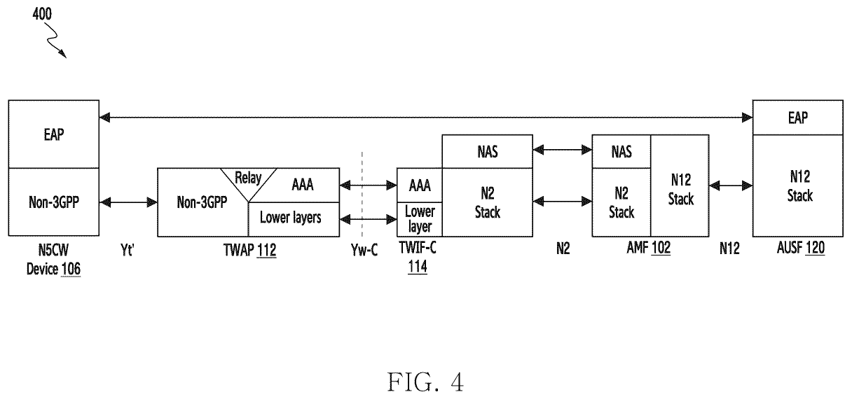

FIG. 4 is a diagram illustrating a control plane connection (400), according to various embodiments. In the disclosed TWIF CUPS architecture, all the control plane protocols are moved to the TWIF-C entity (114).

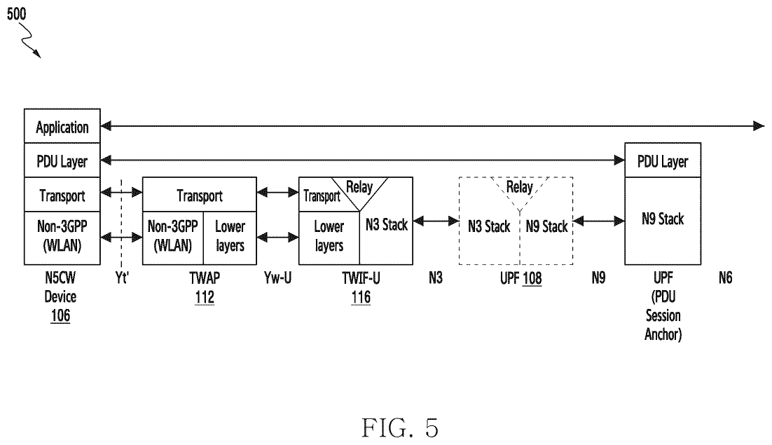

FIG. 5 is a diagram illustrating user plane connectivity (500) and a user plane terminating at a TWIF-U entity (116), according to various embodiments. For example, the UPF (108) is communicated with UPF that operates as a PDU session anchor through an N9 interface related to an N9 stack. In the disclosed TWIF CUPS architecture, all the user plane protocols are moved to the TWIF-U entity (116).

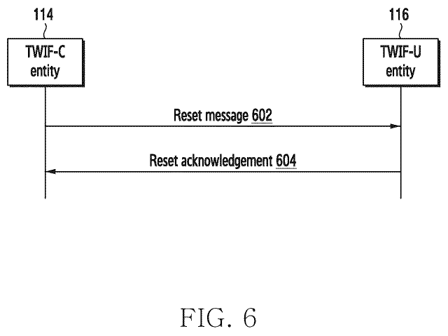

FIG. 6 is a signal flow diagram illustrating an example reset procedure initiated from the TWIF-C entity (114), according to various embodiments. As shown in FIG. 6, at step 602, the TWIF-C entity (114) sends a reset message (e.g., E13AP:RESET message or the like) to the TWIF-U entity (116). Based on the reset message, at step 604, the TWIF-U entity (116) sends a reset acknowledgement (e.g., E13AP:RESET ACKNOWLEDGE message or the like) to the TWIF-C entity (114).

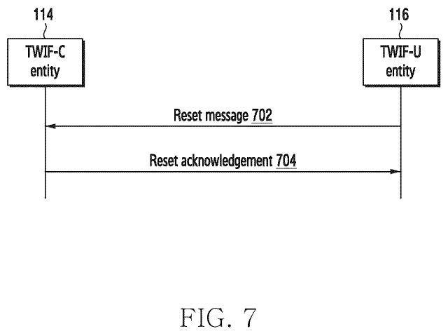

FIG. 7 is a signal flow diagram illustrating an example reset procedure initiated from the TWIF-U entity (116), according to various embodiments. As shown in FIG. 7, at step 702, the TWIF-U entity (116) sends the reset message (e.g., E13AP:RESET message or the like) to the TWIF-C entity (114). Based on the reset message, at step 704, the TWIF-C entity (114) sends the reset acknowledgement (e.g., E13AP:RESET ACKNOWLEDGE message or the like) to the TWIF-U entity (116).

As shown in FIG. 6 and FIG. 7, the reset message is sent by both the TWIF-C entity (114) and the TWIF-U entity (116) and is used to request that the E13 interface, or parts of the E13 interface, to be reset. Information in the reset message is shown in Table 1. In the Table 1, the presence (e.g., M (mandatory), O (optional)) is merely illustrative and may be changed. For example, ‘O’ of IE may be changed to ‘M’.

TABLE 1

| IE/Group Name | Presence | Range |
|---|---|---|
| Message Type | M | |
| | (Mandatory) | |
| Transaction ID | M | |
| Cause | M | |
| CHOICE Reset | M | |
| Type | | |
| >E13 interface | | |
| >>Reset All | M | |
| >Part of E13 | | |
| interface | | |
| >>UE-associated | | 1 |
| logical E13- | | |
| connection list | | |
| >>>UE- | | 1 . . . <maxnoofIndividualE13ConnectionsToReset> |
| associated logical | | |
| E13-connection | | |
| Item | | |
| >>>>TWIF-C | O | |
| UE E13AP ID | (optional) | |
| >>>>TWIF-U | O | |
| UE E13AP ID | | |

Further, maxnoofIndividualE13ConnectionsToReset may refer, for example, to the Maximum number of UE-associated logical E13-connections allowed to reset in one message and value is 65536.

The reset acknowledge message is sent by both the TWIF-C entity (114) and the TWIF-U entity (116) as a response to the reset message. Information in the reset acknowledge message is shown in Table 2. In the Table 2, the presence (e.g., M (mandatory), O (optional)) is merely illustrative and may be changed. For example, ‘O’ of IE may be changed to ‘M’.

TABLE 2

| IE/Group Name | Presence | Range |
|---|---|---|
| Message Type | M | |
| Transaction ID | M | |
| UE-associated | | 0 . . . 1 |
| logical E13- | | |
| connection list | | |
| >UE-associated | | 1 . . . <maxnoofIndividualE13ConnectionsToReset> |
| logical E13- | | |
| connection Item | | |
| >>TWIF-C UE | O | |
| E13AP ID | | |
| >>TWIF-U UE | O | |
| E13AP ID | | |
| Criticality | O | |
| Diagnostics | | |

In an embodiment, maxnoofIndividualE13ConnectionsToReset may refer, for example, to the Maximum number of UE-associated logical E13-connections allowed to reset in one message and value is 65536.

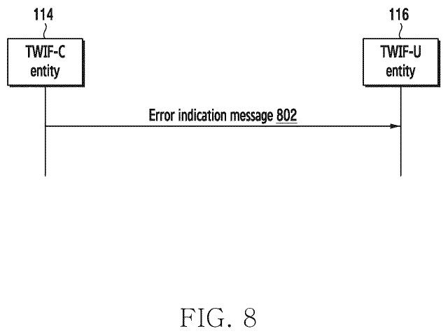

FIG. 8 is a signal flow diagram illustrating an example error indication procedure originated at the TWIF-C entity (114), according to various embodiments. As shown in FIG. 8, At step 802, the TWIF-C entity (114) sends the error indication message (e.g., E13AP:ERROR INDICATION message or the like) to the TWIF-U entity (116).

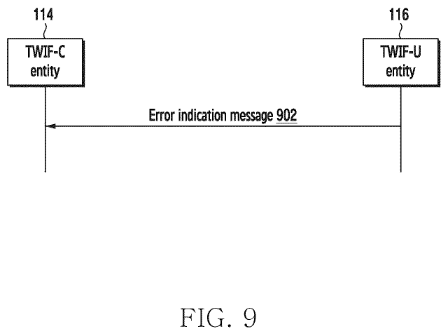

FIG. 9 is a signal flow diagram illustrating an example error indication procedure originated at the TWIF-U entity (116), according to various embodiments. As shown in FIG. 9, At step 902, the TWIF-U entity (116) sends the error indication message (e.g., E13AP:ERROR INDICATION message or the like) to the TWIF-C entity (114).

The error indication message is sent by both the TWIF-C entity (114) and the TWIF-U entity (116) and is used to indicate that some error has been detected in the node. Information in the error indication message is shown in Table 3. In the Table 3, the presence (e.g., M (mandatory), O (optional)) is merely illustrative and may be changed. For example, ‘O’ of IE may be changed to ‘M’.

TABLE 3

| IE/Group Name | Presence |
|---|---|
| Message Type | M |
| Transaction ID | M |
| TWIF-C UE E13AP ID | O |
| TWIF-U UE E13AP ID | O |
| Cause | O |
| Criticality Diagnostics | O |

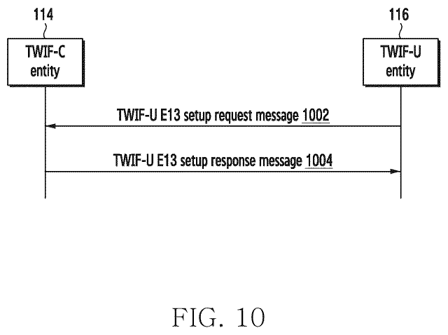

FIG. 10 is a signal flow diagram illustrating an example TWIF-U E13 setup procedure during a success scenario, according to various embodiments. As shown in FIG. 10, at step 1002, the TWIF-U entity (116) sends the TWIF-U E13 setup request message (e.g., E13AP:TWIF-U E13 SETUP REQUEST message or the like) to the TWIF-C entity (114). Based on the TWIF-U E13 setup request message, at step 1004, the TWIF-C entity (114) sends the TWIF-U E13 setup response message (e.g., E13AP:TWIF-U E13 SETUP RESPONSE message or the like) to the TWIF-U entity (116).

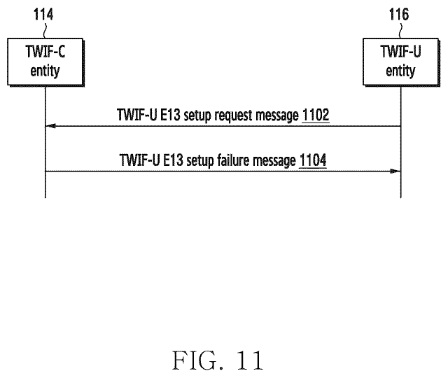

FIG. 11 is a signal flow diagram illustrating an example TWIF-U E13 setup procedure during a failure scenario, according to various embodiments. As shown in FIG. 11, at step 1102, the TWIF-U entity (116) sends the TWIF-U E13 setup request message to the TWIF-C entity (114). Based on the TWIF-U E13 setup request message, at step 1104, the TWIF-C entity (114) sends the TWIF-U E13 setup failure message (e.g., E13AP:TWIF-U E13 SETUP FAILURE message or the like) to the TWIF-U entity (116).

The TWIF-U E13 setup request message is sent by the TWIF-U entity (116) to transfer information for a TNL association. Information in the TWIF-U E13 setup request message is shown in Table 4. In the Table 4, the presence (e.g., M (mandatory), O (optional)) is merely illustrative and may be changed. For example, ‘O’ of IE may be changed to ‘M’.

TABLE 4

| IE/Group Name | Presence | Range |
|---|---|---|
| Message Type | M | |
| Transaction ID | M | |
| TWIF-U ID | M | |
| TWIF-U Name | O | |
| CN Support | M | |
| Supported PLMNs | | 1 . . . <maxnoofSPLMNs> |
| >PLMN Identity | M | |
| >Slice Support List | O | |
| >Extended Slice Support | O | |
| List | | |
| >QoS Parameters | O | |
| Support List | | |
| TWIF-U Capacity | O | |
| Transport Network Layer | O | |
| Address Info | | |
| Extended TWIF-U Name | O | |

In an embodiment, maxnoofSPLMNs indicates the maximum number of Supported PLMN Ids and the value is 12.

The TWIF-U E13 setup response message is sent by the TWIF-C entity (114) to transfer information for a TNL association. Information in the TWIF-U E13 setup response message is shown in Table 5. In the Table 5, the presence (e.g., M (mandatory), O (optional)) is merely illustrative and may be changed. For example, ‘O’ of IE may be changed to ‘M’.

TABLE 5

| IE/Group Name | Presence |
|---|---|
| Message Type | M |
| Transaction ID | M |
| TWIF-C Name | O |
| Transport Network Layer Address Info | O |
| Extended TWIF-C Name | O |
| Criticality Diagnostics | O |

The TWIF-U E13 setup failure message is sent by the TWIF-C entity (114) to indicate E13 setup failure. Information in the TWIF-U E13 setup failure message is shown in Table 6. In the Table 6, the presence (e.g., M (mandatory), O (optional)) is merely illustrative and may be changed. For example, ‘O’ of IE may be changed to ‘M’.

TABLE 6

| IE/Group Name | Presence |
|---|---|
| Message Type | M |
| Transaction ID | M |
| Cause | M |
| Time To wait | O |
| Criticality Diagnostics | O |

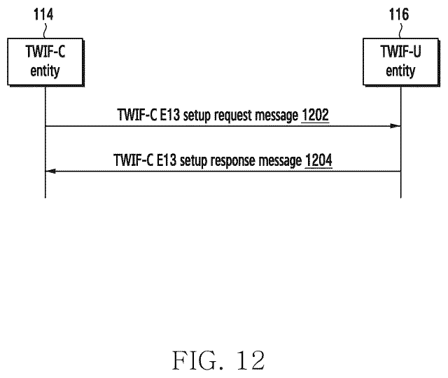

FIG. 12 is a signal flow diagram illustrating an example TWIF-C E13 setup procedure during a success scenario, according to various embodiments. As shown in FIG. 12, at step 1202, the TWIF-C entity (114) sends a TWIF-C E13 setup request message (e.g., E13AP:TWIF-C E13 SETUP REQUEST message or the like) to the TWIF-U entity (116). Based on the TWIF-C E13 setup request message, at step 1204, the TWIF-U entity (116) sends the TWIF-C E13 setup response message (e.g., E13AP:TWIF-C E13 SETUP RESPONSE message or the like) to the TWIF-C entity (114).

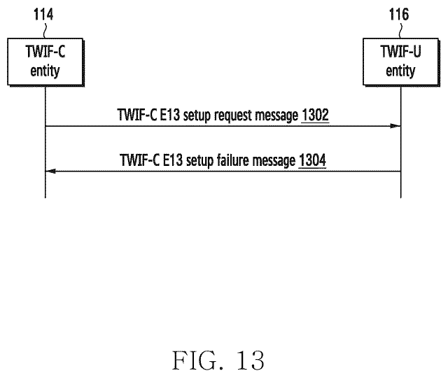

FIG. 13 is a signal flow diagram illustrating an example TWIF-C E13 setup procedure during a failure scenario, according to various embodiments. As shown in FIG. 13, at step 1302, the TWIF-C entity (114) sends a TWIF-C E13 setup request message to the TWIF-U entity (116). Based on the TWIF-C E13 setup request message, at step 1304, the TWIF-U entity (116) sends the TWIF-C E13 setup failure message (e.g., E13AP:TWIF-C E13 SETUP FAILURE message or the like) to the TWIF-C entity (114).

The TWIF-C E13 setup request message is sent by the TWIF-C to transfer information for a TNL association. Information in the TWIF-C E13 setup request message is shown in Table 7. In the Table 7, the presence (e.g., M (mandatory), O (optional)) is merely illustrative and may be changed. For example, ‘O’ of IE may be changed to ‘M’.

TABLE 7

| IE/Group Name | Presence |
|---|---|
| Message Type | M |
| Transaction ID | M |
| TWIF-C Name | O |
| Transport Network Layer Address Info | O |
| Extended TWIF-C Name | O |

The TWIF-C E13 setup response message is sent by the TWIF-U entity (116) to transfer information for a TNL association. The MaxnoofSPLMNs indicates the maximum number of supported PLMN Ids and value is 12. Information in the TWIF-C E13 setup response message is shown in Table 8. In the Table 8, the presence (e.g., M (mandatory), O (optional)) is merely illustrative and may be changed. For example, ‘O’ of IE may be changed to ‘M’.

TABLE 8

| IE/Group Name | Presence | Range |
|---|---|---|
| Message Type | M | |
| Transaction ID | M | |
| TWIF-U ID | M | |
| TWIF-U Name | O | |
| CN Support | M | |
| Supported PLMNs | | 1 . . . <maxnoofSPLMNs> |
| >PLMN Identity | M | |
| >Slice Support List | O | |
| >Extended Slice Support List | O | |
| >QoS Parameters Support List | O | |
| TWIF-U Capacity | O | |
| Transport Network Layer | O | |
| Address Info | | |
| Extended TWIF-U Name | O | |
| Criticality Diagnostics | O | |

The TWIF-C E13 setup failure message is sent by the TWIF-U entity (116) to indicate E13 setup failure. Information in the TWIF-C E13 setup failure message is shown in Table 9. In the Table 9, the presence (e.g., M (mandatory), O (optional)) is merely illustrative and may be changed. For example, ‘O’ of IE may be changed to ‘M’.

TABLE 9

| IE/Group Name | Presence |
|---|---|
| Message Type | M |
| Transaction ID | M |
| Cause | M |
| Time To wait | O |
| Criticality Diagnostics | O |

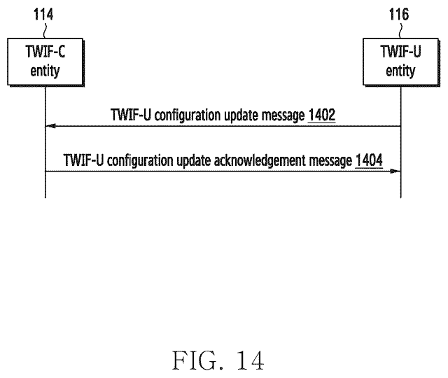

FIG. 14 is a signal flow diagram illustrating an example TWIF-U configuration update procedure during a success scenario, according to various embodiments. As shown in FIG. 14, at step 1402, the TWIF-U entity (116) sends a TWIF-U configuration update message (e.g., E13AP:TWIF-U CONFIGURATION UPDATE message or the like) to the TWIF-C entity (114). Based on the TWIF-U configuration update message, at step 1404, the TWIF-C entity (114) sends the TWIF-U configuration update acknowledgement message (e.g., E13AP:TWIF-U CONFIGURATION UPDATE ACKNOWLEDGE message or the like) to the TWIF-U entity (116).

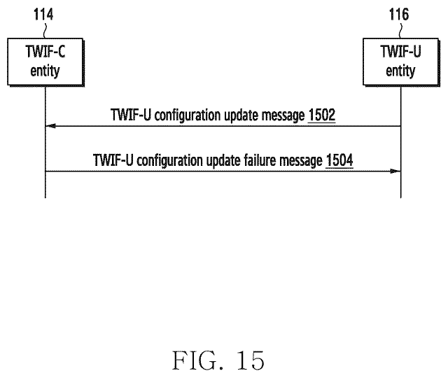

FIG. 15 is a signal flow diagram illustrating an example TWIF-U configuration update procedure during a failure scenario, according to various embodiments. As shown in FIG. 15, at step 1502, the TWIF-U entity (116) sends a TWIF-U configuration update message to the TWIF-C entity (114). Based on the TWIF-U configuration update message, at step 1504, the TWIF-C entity (114) sends the TWIF-U configuration update failure message (e.g., E13AP:TWIF-U CONFIGURATION UPDATE FAILURE message or the like) to the TWIF-U entity (116).

The TWIF-U configuration update message is sent by the TWIF-U to transfer updated information for a TNL association. Information of the TWIF-U configuration update message is shown in Table 10. In an embodiment, maxnoofSPLMNs indicates the maximum number of supported PLMN Ids and value is 12. In an embodiment, maxnoofTNLAssociations indicates the maximum number of TNL associations between the TWIF-U (116) and the TWIF-C (114) and value is 32. In the Table 10, the presence (e.g., M (mandatory), O (optional)) is merely illustrative and may be changed. For example, ‘O’ of IE may be changed to ‘M’.

TABLE 10

| IE/Group Name | Presence | Range |
|---|---|---|
| Message Type | M | |
| Transaction ID | M | |
| TWIF-U ID | O | |
| TWIF-U Name | O | |
| Supported PLMNs | | 0 . . . < maxnoofSPLMNs> |
| >PLMN Identity | M | |
| >Slice Support List | O | |
| >Extended Slice | O | |
| Support List | | |
| >QoS Parameters | O | |
| Support List | | |
| TWIF-U Capacity | O | |
| TWIF-U TNLA To | | 0.1 |
| Remove List | | |
| >TWIF-U TNLA To | | 1 . . .< maxnoofTNLAssociations> |
| Remove Item IEs | | |
| >>TNLA Transport | M | |
| Layer Address | | |
| >>TNLA Transport | O | |
| Layer Address | | |
| TWIF-C | | |
| Transport Network | O | |
| Layer Address Info | | |
| Extended TWIF-U | O | |
| Name | | |

The TWIF-U configuration update acknowledge message is sent by the TWIF-C entity (114) to the TWIF-U entity (114) to acknowledge update of information for a TNL association. Information in the TWIF-U configuration update acknowledge message is shown in Table 11. In the Table 11, the presence (e.g., M (mandatory), O (optional)) is merely illustrative and may be changed. For example, ‘O’ of IE may be changed to ‘M’.

TABLE 11

| IE/Group Name | Presence |
|---|---|
| Message Type | M |
| Transaction ID | M |
| Criticality Diagnostics | O |
| Transport Network Layer Address Info | O |

The TWIF-U configuration update failure message is sent by the TWIF-C entity (114) to indicate TWIF-U configuration update failure. Information in the TWIF-U configuration update failure message is shown in Table 12. In the Table 12, the presence (e.g., M (mandatory), O (optional)) is merely illustrative and may be changed. For example, ‘O’ of IE may be changed to ‘M’.

TABLE 12

| IE/Group Name | Presence |
|---|---|
| Message Type | M |
| Transaction ID | M |
| Cause | M |
| Time To wait | O |
| Criticality Diagnostics | O |

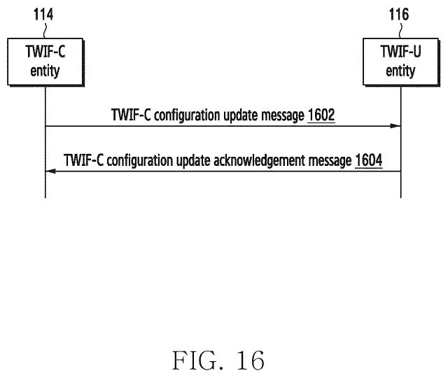

FIG. 16 is a signal flow diagram illustrating an example TWIF-C configuration update procedure during a success scenario, according to various embodiments. As shown in FIG. 16, at step 1602, the TWIF-C entity (114) sends a TWIF-C configuration update message (e.g., E13AP:TWIF-C CONFIGURATION UPDATE message or the like) to the TWIF-U entity (116). Based on the TWIF-C configuration update message, at step 1604, the TWIF-U entity (116) sends the TWIF-C configuration update acknowledgement message (e.g., E13AP:TWIF-C CONFIGURATION UPDATE ACKNOWLEDGE message or the like) to the TWIF-C entity (114).

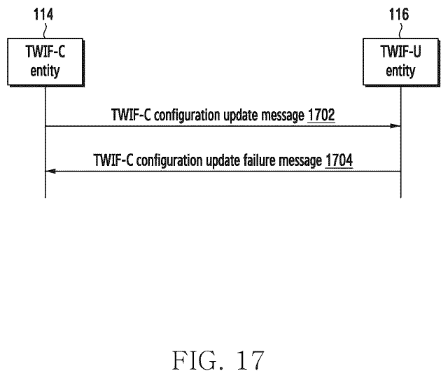

FIG. 17 is a signal flow diagram illustrating an example TWIF-C configuration update procedure during a failure scenario, according to various embodiments. As shown in FIG. 17, at step 1702, the TWIF-C entity (114) sends the TWIF-C configuration update message to the TWIF-U entity (116). Based on the TWIF-C configuration update message, at step 1704, the TWIF-U entity (116) sends the TWIF-C configuration update failure message (e.g., E13AP:TWIF-C CONFIGURATION UPDATE FAILURE message or the like) to the TWIF-C entity (114).

The TWIF-C configuration update message is sent by the TWIF-C to transfer updated information for a TNL association. MaxnoofTNLAssociations indicates that maximum number of TNL Associations between the TWIF-C entity (114) and the TWIF-U entity (116). Value for the MaxnoofTNLAssociations is 32. Information in the TWIF-C configuration update message is shown in Table 13. In the Table 13, the presence (e.g., M (mandatory), O (optional)) is merely illustrative and may be changed. For example, ‘O’ of IE may be changed to ‘M’.

TABLE 13

| IE/Group Name | Presence | Range |
|---|---|---|
| Message Type | M | |
| Transaction ID | M | |
| TWIF-C Name | O | |
| TWIF-C TNLA To Add | | 0 . . . 1 |
| List | | |
| >TWIF-C TNLA To Add | | 1 . . . |
| Item IEs | | <maxnoofTNLAssociations> |
| >>TNLA Transport Layer | M | |
| Information | | |
| >>TNLA Usage | M | |
| TWIF-C TNLA To Remove | | 0 . . . 1 |
| List | | |
| >TWIF-C TNLA To | | 1 . . . |
| Remove Item IEs | | <maxnoofTNLAssociations> |
| >>TNLA Transport Layer | M | |
| Address | | |
| >>TNLA Transport Layer | O | |
| Address TWIF-U | | |
| TWIF-C TNLA To Update | | 0 . . . 1 |
| List | | |
| >TWIF-C TNLA To | | 1 . . . |
| Update Item IEs | | <maxnoofTNLAssociations> |
| >>TNLA Transport Layer | M | |
| Address | | |
| >>TNLA Usage | O | |
| Transport Network Layer | O | |
| Address Info | | |
| Extended TWIF-C Name | O | |

The TWIF-C configuration update acknowledge message is sent by the TWIF-U entity (116) to the TWIF-C entity (114) to acknowledge update of information for a TNL association. Information in the TWIF-C configuration update acknowledge message is shown in Table 14. In the Table 14, the presence (e.g., M (mandatory), O (optional)) is merely illustrative and may be changed. For example, ‘O’ of IE may be changed to ‘M’.

TABLE 14

| IE/Group Name | Presence | Range |
|---|---|---|
| Message Type | M | |
| Transaction ID | M | |
| TWIF-C TNLA Setup List | | 0 . . . 1 |
| >TWIF-C TNLA Setup Item | | 1 . . . |
| IEs | | <maxnoofTNLAssociations> |
| >>TNLA Transport Layer | M | |
| Address | | |
| TWIF-C TNLA Failed to | | 0 . . . 1 |
| Setup List | | |
| >TWIF-C TNLA Failed To | | 1 . . . |
| Setup Item IEs | | <maxnoofTNLAssociations> |
| >>TNLA Transport Layer | M | |
| Address | | |
| >>Cause | M | |
| Criticality Diagnostics | O | |
| Transport Network Layer | O | |
| Address Info | | |

The TWIF-C configuration update failure message is sent by the TWIF-U entity (116) to indicate TWIF-C Configuration Update failure. Information in the TWIF-C configuration update failure message is shown in Table 15. In the Table 15, the presence (e.g., M (mandatory), O (optional)) is merely illustrative and may be changed. For example, ‘O’ of IE may be changed to ‘M’.

TABLE 15

| IE/Group Name | Presence |
|---|---|
| Message Type | M |
| Transaction ID | M |
| Cause | M |
| Time To wait | O |
| Criticality Diagnostics | O |

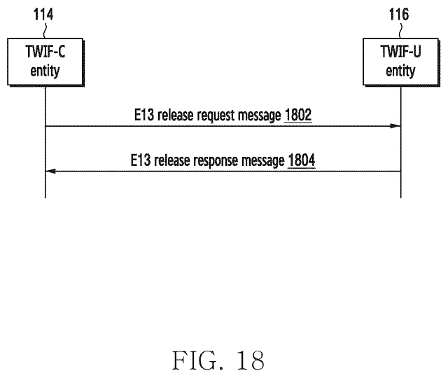

FIG. 18 is a signal flow diagram illustrating an example E13 release procedure initiated from the TWIF-C entity (114), according to various embodiments. As shown in FIG. 18, at step 1802, the TWIF-C entity (114) sends an E13 release request message (e.g., E13AP:E13 RELEASE REQUEST message or the like) to the TWIF-U entity (116). Based on the E13 release request message, at step 1804, the TWIF-U entity (116) sends the E13 release response message (e.g., E13AP:E13 RELEASE RESPONSE message or the like) to the TWIF-C entity (114).

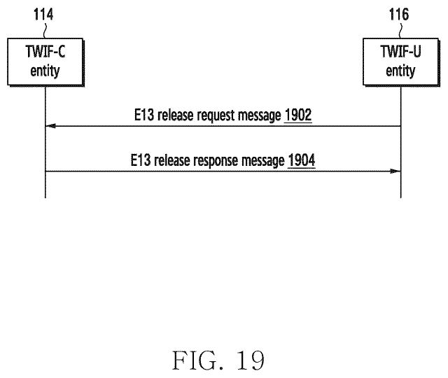

FIG. 19 is a signal flow diagram illustrating an example E13 Release procedure initiated from the TWIF-U entity (116), according to various embodiments. As shown in FIG. 19, at step 1902, the TWIF-U entity (116) sends a E13 release request message (e.g., E13AP:E13 RELEASE REQUEST message or the like) to the TWIF-C entity (114). Based on the E13 release request message, at step 1904, the TWIF-C entity (114) sends the E13 release response message (e.g., E13AP:E13 RELEASE RESPONSE message or the like) to the TWIF-U entity (116).

The E13 release request message is sent by both the TWIF-C entity (114) and the TWIF-U entity (116) and is used to request the release of the E13 interface. Information in the E13 release request message is shown in Table 16.

TABLE 16

| IE/Group Name | Presence |
|---|---|
| Message Type | M |
| Transaction ID | M |
| Cause | M |

The E13 release response message is sent by both the TWIF-C entity (114) and the TWIF-U entity (116) as a response to an E13 RELEASE REQUEST message. Information in the E13 release response message is shown in Table 17. In the Table 17, the presence (e.g., M (mandatory), O (optional)) is merely illustrative and may be changed. For example, ‘O’ of IE may be changed to ‘M’.

TABLE 17

| IE/Group Name | Presence |
|---|---|
| Message Type | M |
| Transaction ID | M |
| Criticality Diagnostics | O |

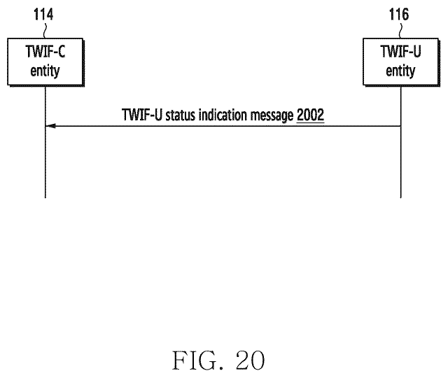

FIG. 20 is a signal flow diagram illustrating an example TWIF-U status indication, according to various embodiments. As shown in FIG. 20, at step 2002, the TWIF-U entity (116) sends a TWIF-U status indication message (e.g., E13AP:TWIF-U STATUS INDICATION message or the like) to the TWIF-C entity (114).

The TWIF-U status indication message is sent by the TWIF-U entity (116) to indicate to the TWIF-C its status of overload. Information in the TWIF-U status indication message is shown in Table 18.

TABLE 18

| IE/Group Name | Presence |
|---|---|
| Message Type | M |
| Transaction ID | M |
| TWIF-U Overload Information | M |

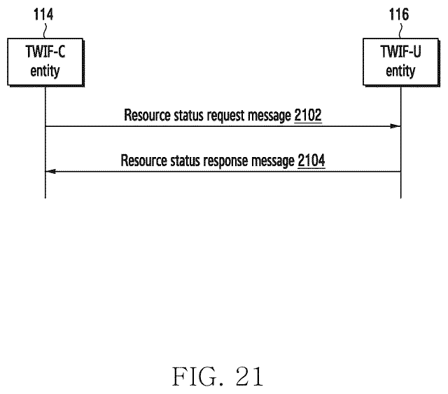

FIG. 21 is a signal flow diagram illustrating example resource status reporting initiation during a success scenario, according to various embodiments. As shown in FIG. 21, at step 2102, the TWIF-C entity (114) sends a resource status request message (e.g., E13AP:RESOURCE STATUS REQUEST message or the like) to the TWIF-U entity (116). Based on the resource status request message, at step 2104, the TWIF-U entity (116) sends the resource status response message (e.g., E13AP:RESOURCE STATUS RESPONSE message or the like) to the TWIF-C entity (114).

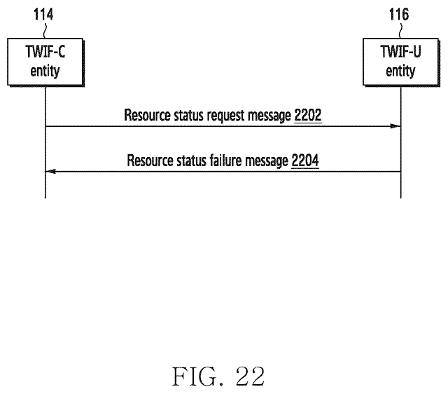

FIG. 22 is a signal flow diagram illustrating example resource status reporting initiation during a failure scenario, according to various embodiments. As shown in FIG. 22, at step 2202, the TWIF-C entity (114) sends the resource status request message (e.g., E13AP:RESOURCE STATUS REQUEST message or the like) to the TWIF-U entity (116). Based on the resource status request message, at step 2204, the TWIF-U entity (116) sends the resource status failure message (e.g., E13AP:RESOURCE STATUS FAILURE message or the like) to the TWIF-C entity (114).

The resource status request message is sent by an TWIF-C entity (116) to the TWIF-U entity (116) to initiate the requested measurement according to the parameters given in the message. Information in the resource status request message is shown in Table 19 and Table 20. In the Table 19, the presence (e.g., M (mandatory), O (optional)) is merely illustrative and may be changed. For example, ‘O’ of IE may be changed to ‘M’.

TABLE 19

| IE/Group Name | Presence |
|---|---|
| Message Type | M |
| Transaction ID | M |
| TWIF-C Measurement ID | M |
| TWIF-U Measurement ID | C-ifRegistrationRequestStop |
| Registration Request | M |
| Report Characteristics | C-ifRegistrationRequestStart |
| Reporting Periodicity | O |

TABLE 20

| Condition | Explanation |
|---|---|
| ifRegistrationRequestStop | This IE shall be present if the |
| | Registration Request IE is set to |
| | the value “stop” |
| ifRegistrationRequestStart | This IE shall be present if the |
| | Registration Request IE is set to |
| | the value “start”. |

The resource status response message is sent by the TWIF-U entity (116) to indicate that the requested measurement, for all the measurement objects included in the measurement is successfully initiated. Information in the resource status response message is shown in Table 21. In the Table 21, the presence (e.g., M (mandatory), O (optional)) is merely illustrative and may be changed. For example, ‘O’ of IE may be changed to ‘M’.

TABLE 21

| IE/Group Name | Presence |
|---|---|
| Message Type | M |
| Transaction ID | M |
| TWIF-C Measurement ID | M |
| TWIF-U Measurement ID | M |
| Criticality Diagnostics | O |

The resource status failure message is sent by the TWIF-U entity (116) to indicate that for any of the requested measurement objects the measurement cannot be initiated. Information in the resource status failure message is shown in Table 22 and Table 23. In the Table 22, the presence (e.g., M (mandatory), O (optional)) is merely illustrative and may be changed. For example, ‘O’ of IE may be changed to ‘M’.

TABLE 22

| IE/Group Name | Presence |
|---|---|
| Message Type | M |
| Transaction ID | M |
| TWIF-C Measurement ID | M |
| TWIF-U Measurement ID | C-ifRegistrationRequestStop |
| Cause | M |
| Criticality Diagnostics | O |

TABLE 23

| Condition | Explanation |
|---|---|
| ifRegistrationRequestStop | This IE shall be present if the Registration |
| | Request IE is set to the value “stop” |

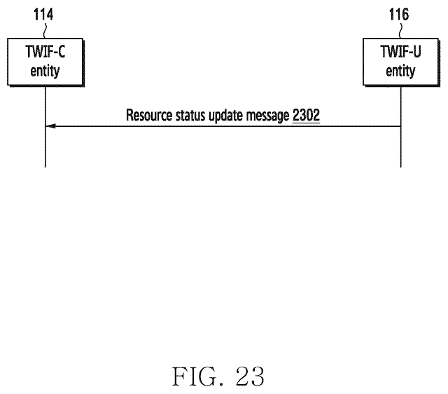

FIG. 23 is a signal flow diagram illustrating example resource status reporting during a success scenario, according to various embodiments. As shown in FIG. 23, at step 2302, the TWIF-U entity (116) sends a resource status update message (e.g., E13AP:RESOURCE STATUS UPDATE message or the like) to the TWIF-C entity (114).

The resource status update message is sent by TWIF-U entity (116) to the TWIF-C entity (114) to report the results of the requested measurements. Information in the resource status update message is shown in Table 24 and Table 25. In the Table 24, the presence (e.g., M (mandatory), O (optional)) is merely illustrative and may be changed. For example, ‘O’ of IE may be changed to ‘M’.

TABLE 24

| IE/Group Name | Presence |
|---|---|
| Message Type | M |
| Transaction ID | M |
| TWIF-C Measurement ID | M |
| TWIF-U Measurement ID | M |
| TNL Available Capacity | O |
| Indicator | |
| HW Capacity Indicator | O |

TABLE 25

| Range bound | Explanation |
|---|---|
| maxnoofSPLMNs | Maximum no. of Supported PLMN |
| | Ids. Value is 12. |
| maxnoofSliceItems | Maximum no. of signalled slice |
| | support items. Value is 1024. |

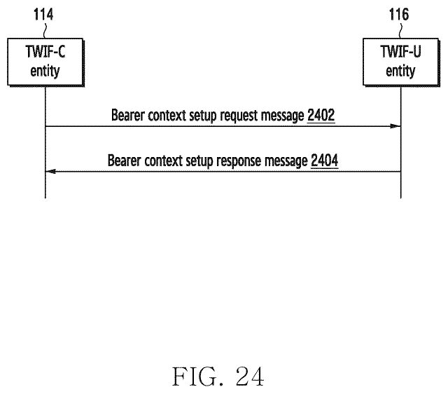

FIG. 24 is a signal flow diagram illustrating an example bearer context setup procedure during a success scenario, according to various embodiments. As shown in FIG. 24, at step 2402, the TWIF-C entity (114) sends a bearer context setup request message (e.g., E13AP:BEARER CONTEXT SETUP REQUEST message or the like) to the TWIF-U entity (116). Based on the bearer context setup request message, at step 2404, the TWIF-U entity (116) sends the bearer context setup response message (e.g., E13AP:BEARER CONTEXT SETUP RESPONSE message or the like) to the TWIF-C entity (114).

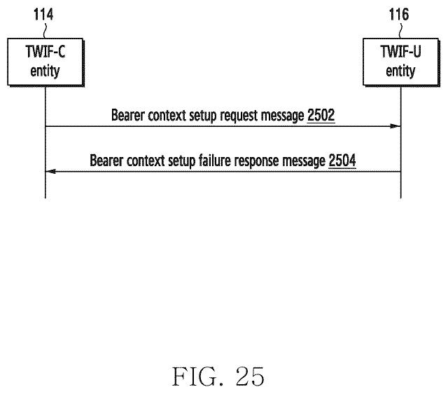

FIG. 25 is a signal flow diagram illustrating an example bearer context setup procedure during a failure scenario, according to various embodiments. As shown in FIG. 25, at step 2502, the TWIF-C entity (114) sends the bearer context setup request message (e.g., E13AP:BEARER CONTEXT SETUP REQUEST message or the like) to the TWIF-U entity (116). Based on the bearer context setup request message, at step 2504, the TWIF-U entity (116) sends the bearer context setup failure response message (e.g., E13AP:BEARER CONTEXT SETUP FAILURE RESPONSE message or the like) to the TWIF-C entity (114).

The bearer context setup request message is sent by the TWIF-C entity (114) to request the TWIF-U entity (116) to setup a bearer context. Information in the bearer context setup request message is shown in Table 26. In the Table 26, the presence (e.g., M (mandatory), O (optional)) is merely illustrative and may be changed. For example, ‘O’ of IE may be changed to ‘M’.

TABLE 26

| IE/Group Name | Presence |
|---|---|
| Message Type | M |
| TWIF-C UE E13AP ID | M |
| Security Information | M |
| Serving PLMN | M |
| Activity Notification Level | M |
| UE Inactivity Timer | O |
| Bearer Context Status Change | O |
| TWIF assigned UE IP address | M |
| TWIF | |
| >PDU Session Resource To Setup List | M |
| >>PDU Session Resource To Setup Item | M |
| >>>PDU Session ID | M |
| >>>PDU Session Type | M |
| >>>Security Indication | O |
| >>>S-NSSAI | M |
| >>>NG UL UP Transport Layer Information | M |
| >>>PDU Session Inactivity Timer | O |
| . . . | |
| TWIF UE ID | O |
| Trace Activation | O |

The bearer context setup response message is sent by the TWIF-U entity (116) to confirm the setup of the requested bearer context. Information in the bearer context setup response message is shown in Table 27. In the Table 27, the presence (e.g., M (mandatory), O (optional)) is merely illustrative and may be changed. For example, ‘O’ of IE may be changed to ‘M’.

TABLE 27

| Message Type | Presence |
|---|---|
| TWIF-C UE E13AP ID | M |
| TWIF-U UE E13AP ID | M |
| TWIF | M |
| >PDU Session Resource Setup List | M |
| >>PDU Session Resource Setup Item | M |
| >>>PDU Session ID | M |
| >>>Security Result | O |
| >>>NG DL UP Transport Layer Information | M |
| . . . | |
| >PDU Session Resource Failed List | O |
| >>PDU Session Resource Failed Item | M |
| >>>PDU Session ID | M |
| >>>Cause | M |

The bearer context setup failure message is sent by the TWIF-U entity (116) to indicate that the setup of the bearer context was unsuccessful. Information in the bearer context setup failure message is shown in Table 28. In the Table 28, the presence (e.g., M (mandatory), O (optional)) is merely illustrative and may be changed. For example, ‘O’ of IE may be changed to ‘M’.

TABLE 28

| IE/Group Name | Presence |
|---|---|
| Message Type | M |
| TWIF-C UE E13AP ID | M |
| TWIF-U UE E13AP ID | O |
| Cause | M |
| Criticality Diagnostics | O |

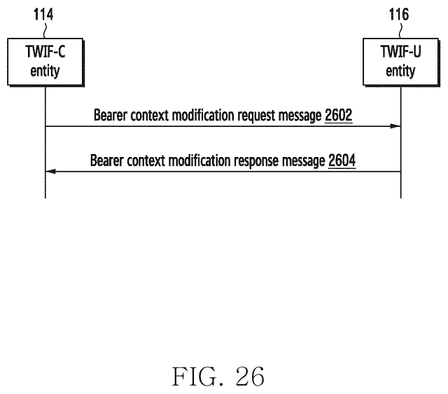

FIG. 26 is a signal flow diagram illustrating an example bearer context modification procedure during a success scenario, according to various embodiments. As shown in FIG. 26, at step 2602, the TWIF-C entity (114) sends the bearer context modification request message (e.g., E13AP:BEARER CONTEXT MODIFICATION REQUEST message or the like) to the TWIF-U entity (116). Based on the bearer context modification request message, at step 2604, the TWIF-U entity (116) sends the bearer context modification response message (e.g., E13AP:BEARER CONTEXT MODIFICATION RESPONSE message or the like) to the TWIF-C entity (114).

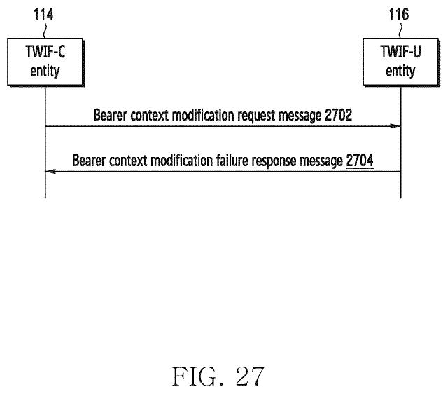

FIG. 27 is a signal flow diagram illustrating an example bearer context modification procedure during a failure scenario, according to various embodiments. As shown in FIG. 27, at step 2702, the TWIF-C entity (114) sends the bearer context modification request message to the TWIF-U entity (116). Based on the bearer context modification request message, at step 2704, the TWIF-U entity (116) sends the bearer context modification failure response message (e.g., E13AP:BEARER CONTEXT MODIFICATION FAILURE response message or the like) to the TWIF-C entity (114).

The bearer context modification request message is sent by the TWIF-C entity (114) to request the TWIF-U entity (116) to modify a bearer context. Information in the bearer context modification request message is shown in Table 29 and Table 30. In the Table 29 and the Table 30, the presence (e.g., M (mandatory), O (optional)) is merely illustrative and may be changed. For example, ‘O’ of IE may be changed to ‘M’.

TABLE 29

| IE/Group Name | Presence |
|---|---|
| Message Type | M |
| TWIF-C UE E13AP ID | M |
| TWIF-U UE E13AP ID | M |
| Security Information | O |
| UE DL Aggregate Maximum Bit Rate | O |
| UE DL Maximum Integrity Protected | O |
| Data Rate | |
| Bearer Context Status Change | O |
| New UL TNL Information Required | O |
| UE Inactivity Timer | O |
| Data Discard Required | O |
| TWIF | |
| >PDU Session Resource To Setup List | O |
| >>PDU Session Resource To Setup Item | M |
| >>>PDU Session ID | M |
| >>>NG UL UP Transport Layer | M |
| Information | |

TABLE 30

| IE/Group Name | Presence |
|---|---|
| >PDU Session Resource To Modify List | O |
| >>PDU Session Resource To Modify Item | M |
| >>>PDU Session ID | M |
| >>>NG UL UP Transport Layer Information | M |
| >PDU Session Resource To Remove List | O |
| >>PDU Session Resource To Remove Item | |
| >>>PDU Session ID | M |
| >>>Cause | O |
| TWIF UE ID | O |
| Activity Notification Level | O |

The bearer context modification response message is sent by the TWIF-C (114) to confirm the modification of the requested bearer context. Information in the bearer context modification response message is shown in Table 31. In the Table 31, the presence (e.g., M (mandatory), O (optional)) is merely illustrative and may be changed. For example, ‘O’ of IE may be changed to ‘M’.

TABLE 31

| IE/Group Name | Presence |
|---|---|
| Message Type | M |
| TWIF-C UE E13AP ID | M |
| TWIF-U UE E13AP ID | M |
| TWIF | |
| >PDU Session Resource Setup List | O |
| >PDU Session Resource Failed List | O |
| >PDU Session Resource Modified List | O |
| >PDU Session Resource Failed To Modify List | O |
| >Retainability Measurements Information | O |

Table 32 shows the PDU session resource failed list IE.

TABLE 32

| IE/Group Name | Presence | Range |
|---|---|---|
| PDU Session | | 1 . . . <maxnoofPDUSessionResource> |
| Resource Failed | | |
| Modification Item | | |
| >PDU Session ID | M | |
| >Cause | M | |

Table 33 shows the PDU session resource setup list IE. In the Table 33, the presence (e.g., M (mandatory), O (optional)) is merely illustrative and may be changed. For example, ‘O’ of IE may be changed to ‘M’.

TABLE 33

| IE/Group Name | Presence | Range |
|---|---|---|
| PDU Session Resource | | 1 . . . <maxnoofPDUSessionResource> |
| Setup Modification | | |
| Item | | |
| >PDU Session ID | M | |
| >Security Result | O | |
| >NG DL UP Transport | M | |
| Layer Information | | |
| >Redundant NG DL | O | |
| UP Transport Layer | | |
| Information | | |

The maxnoofPDUSessionResource indicates the maximum number of PDU Sessions for a UE and value is 256.

Table 34 shows the PDU session resource modified list IE. In the Table 34, the presence (e.g., M (mandatory), O (optional)) is merely illustrative and may be changed. For example, ‘O’ of IE may be changed to ‘M’.

TABLE 34

| IE/Group Name | Presence | Range |
|---|---|---|
| PDU Session Resource Modified Item | | 1 . . . <maxnoofPDUSessionResource> |
| >PDU Session ID | M | |
| >NG DL UP Transport Layer | O | |
| Information | | |
| >Security Result | O | |
| >PDU Session Data Forwarding | O | |
| Information Response | | |
| >Redundant NG DL UP Transport Layer | O | |
| Information | | |

Table 35 and table 36 show PDU session resource failed to modify list IE.

TABLE 35

| IE/Group Name | Presence | Range |
|---|---|---|
| PDU Session | | 1 . . . <maxnoofPDUSessionResource> |
| Resource Failed To | | |
| Modify Item | | |
| >PDU Session ID | M | |
| >Cause | M | |

TABLE 36

| Range bound | Explanation |
|---|---|
| maxnoofPDUSessionResource | Maximum no. of PDU Sessions for |
| | a UE. Value is 256. |

The bearer context modification failure message is sent by the TWIF-U entity (116) to indicate that the modification of the bearer context was unsuccessful. Information in the bearer context modification failure message is shown in table 37. In the Table 37, the presence (e.g., M (mandatory), O (optional)) is merely illustrative and may be changed. For example, ‘O’ of IE may be changed to ‘M’.

TABLE 37

| IE/Group Name | Presence |
|---|---|
| Message Type | M |
| TWIF-C UE E13AP ID | M |
| TWIF-U UE E13AP ID | M |
| Cause | M |
| Criticality Diagnostics | O |

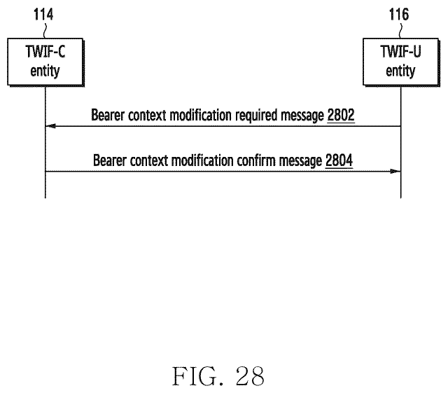

FIG. 28 is a signal flow diagram illustrating an example bearer context modification required procedure during a success scenario, according to various embodiments. As shown in FIG. 28, at step 2802, the TWIF-U entity (116) sends a bearer context modification required message (e.g., E13AP:BEARER CONTEXT MODIFICATION REQUIRED message or the like) to the TWIF-C entity (114). Based on the bearer context modification required message, at step 2804, the TWIF-C entity (114) sends the bearer context modification confirm message (e.g., E13AP:BEARER CONTEXT MODIFICATION CONFIRM message or the like) to the TWIF-U entity (116).

The bearer context modification required message is sent by the TWIF-U entity (116) to inform the TWIF-C entity (114) that a modification of a bearer context is required (e.g., due to local problems at the TWIF-U entity (116)). Information in the bearer context modification required message is shown in Table 38 and Table 39. In the Table 38, the presence (e.g., M (mandatory), O (optional)) is merely illustrative and may be changed. For example, ‘O’ of IE may be changed to ‘M’.

TABLE 38

| IE/Group Name | Presence |
|---|---|
| Message Type | M |
| TWIF-C UE E13AP ID | M |
| TWIF-U UE E13AP ID | M |
| TWIF | |
| >PDU Session Resource To Modify List | O |
| >PDU Session Resource To Remove List | O |

TABLE 39

| Range bound | Explanation |
|---|---|
| maxnoofPDUSessionResource | Maximum no. of PDU Sessions |
| | for a UE. Value is 256. |

Table 40 shows the PDU session resource to modify list IE. In the Table 40, the presence (e.g., M (mandatory), O (optional)) is merely illustrative and may be changed. For example, ‘O’ of IE may be changed to ‘M’.

TABLE 40

| IE/Group Name | Presence | Range |
|---|---|---|
| PDU Session | | 1 . . . <maxnoofPDUSessionResource> |
| Resource Required | | |
| To Modify Item | | |
| >PDU Session ID | M | |
| >NG DL UP | O | |
| Transport Layer | | |
| Information | | |
| >Redundant NG DL | O | |
| UP Transport Layer | | |
| Information | | |

Table 41 shows the PDU session resource to remove list IE. In the Table 41, the presence (e.g., M (mandatory), O (optional)) is merely illustrative and may be changed. For example, ‘O’ of IE may be changed to ‘M’.

TABLE 41

| IE/Group Name | Presence | Range |
|---|---|---|
| PDU Session | | 1 . . . <maxnoofPDUSessionResource> |
| Resource To | | |
| Remove Item | | |
| >PDU Session ID | M | |
| >Cause | O | |

The bearer context modification confirm message is sent by the TWIF-C entity (114) to confirm the modification of the requested bearer context. The Information in the bearer context modification confirm message is shown in Table 42. In the Table 42, the presence (e.g., M (mandatory), O (optional)) is merely illustrative and may be changed. For example, ‘O’ of IE may be changed to ‘M’.

TABLE 42

| IE/Group Name | Presence |
|---|---|
| Message Type | M |
| TWIF-C UE E13AP ID | M |
| TWIF-U UE E13AP ID | M |
| TWIF | |
| >PDU Session Resource Modified List | O |

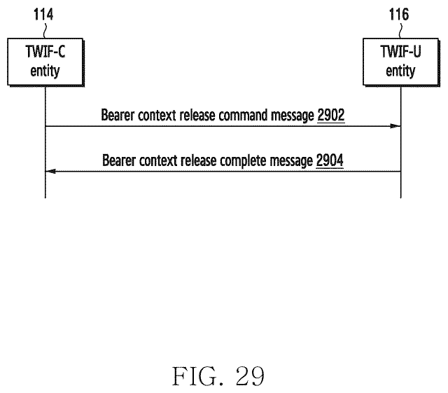

FIG. 29 is a signal flow diagram illustrating an example bearer context release procedure, according to various embodiments. As shown in FIG. 29, at step 2902, the TWIF-C entity (114) sends the bearer context release command message (e.g., E13AP:BEARER CONTEXT RELEASE COMMAND message or the like) to the TWIF-U entity (116). Based on the bearer context release command message, at step 2904, the TWIF-U entity (116) sends the bearer context release complete message (e.g., E13AP:BEARER CONTEXT RELEASE COMPLETE message or the like) to the TWIF-C entity (114).

The bearer context release command message is sent by the TWIF-C entity (114) to command the TWIF-U entity (116) to release an UE-associated logical E13 connection. Information in the bearer context release command message is shown in Table 43.

TABLE 43

| IE/Group Name | Presence |
|---|---|
| Message Type | M |
| TWIF-C UE E13AP ID | M |
| TWIF-U UE E13AP ID | M |
| Cause | M |

The bearer context release complete message is sent by the TWIF-U entity (116) to confirm the release of the UE-associated logical E13 connection. Information in the bearer context release complete message is shown in Table 44. In the Table 44, the presence (e.g., M (mandatory), O (optional)) is merely illustrative and may be changed. For example, ‘O’ of IE may be changed to ‘M’.

TABLE 44

| IE/Group Name | Presence |
|---|---|
| Message Type | M |
| TWIF-C UE E13AP ID | M |
| TWIF-U UE E13AP ID | M |
| Criticality Diagnostics | O |
| Retainability Measurements Information | O |

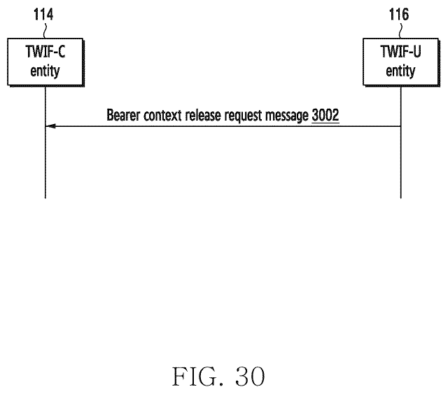

FIG. 30 is a signal flow diagram illustrating an example bearer context release request procedure, according to various embodiments. As shown in FIG. 30, at step 3002, the TWIF-U entity (116) sends a bearer context release request message (e.g., E13AP:BEARER CONTEXT RELEASE REQUEST message or the like) to the TWIF-C entity (114). The bearer context release request message is sent by the TWIF-U entity (116) to request the release of an UE-associated logical E13 connection. Information in the bearer context release request message is shown in Table 45.

TABLE 45

| IE/Group Name | Presence | Range |
|---|---|---|
| Message Type | M | |
| TWIF-C UE E13AP ID | M | |
| TWIF-U UE E13AP ID | M | |
| Cause | M | |

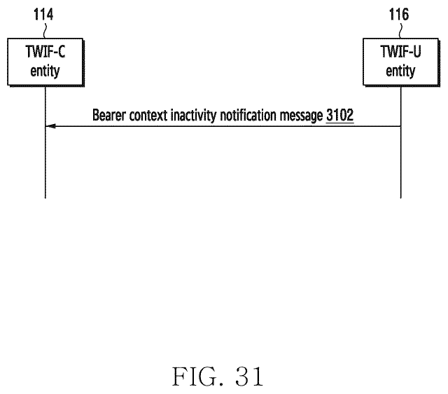

FIG. 31 is a signal flow diagram illustrating an example bearer context inactivity notification procedure, according to various embodiments. As shown in FIG. 31, at step 3102, the TWIF-U entity (116) sends a bearer context inactivity notification message (e.g., E13AP:BEARER CONTEXT INACTIVITY NOTIFICATION message or the like) to the TWIF-C entity (114). The bearer context inactivity notification message (shown in Table 46) is sent by the TWIF-U entity (116) to provide information about the UE activity to the TWIF-C entity (114).

TABLE 46

| IE/Group Name | Presence | Range |
|---|---|---|
| Message Type | M | |
| TWIF-C UE | M | |
| E13AP ID | | |
| TWIF-U UE | M | |
| E13AP ID | | |
| CHOICE Activity | M | |
| Information | | |
| >PDU Session | | 1 |
| Resource | | |
| Activity List | | |
| >>PDU Session | | 1 . . . <maxnoofPDUSessionResource> |
| Resource | | |
| Activity Item | | |
| >>>PDU Session ID | M | |
| >>>PDU Session | M | |
| Resource Activity | | |
| >UE Activity | M | |

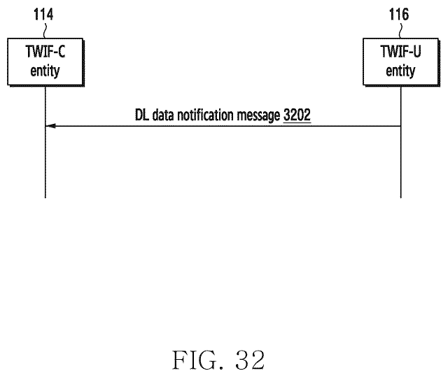

FIG. 32 is a signal flow diagram illustrating an example DL data notification procedure, according to various embodiments. As shown in FIG. 32, at step 3202, the TWIF-U entity (116) sends a DL data notification message (e.g., E13AP:DL DATA NOTIFICATION message or the like) to the TWIF-C entity (114). The DL data notification message is sent by the TWIF-U entity (116) to report data volumes. Information in the DL data notification message is shown in Table 47. In the Table 47, the presence (e.g., M (mandatory), O (optional)) is merely illustrative and may be changed. For example, ‘O’ of IE may be changed to ‘M’.

TABLE 47

| IE/Group Name | Presence | Range |
|---|---|---|
| Message Type | M | |
| TWIF-C UE | M | |
| E13AP ID | | |
| TWIF-U UE | M | |
| E13AP ID | | |
| Paging Priority | O | |
| Indicator (PPI) | | |
| PDU Session To | | 1 |
| Notify List | | |
| >PDU Session To | | 1 . . . <maxnoofPDUSessionResource> |
| Notify Item | | |
| >>PDU Session ID | M | |

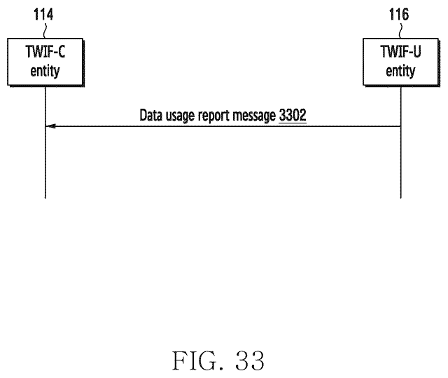

FIG. 33 is a signal flow diagram illustrating an example data usage report procedure, according to various embodiments. As shown in FIG. 33, at step 3302, the TWIF-U entity (116) sends a data usage report message (e.g., E13AP:DATA USAGE REPORT message or the like) to the TWIF-C entity (114). The data usage report message is sent by the TWIF-U entity (116) to report data volumes. Information in the data usage report message is shown in Table 48.

TABLE 48

| IE/Group Name | Presence |
|---|---|
| Message Type | M |
| TWIF-C UE E13AP ID | M |
| TWIF-U UE E13AP ID | M |
| Data Usage Report List | M |

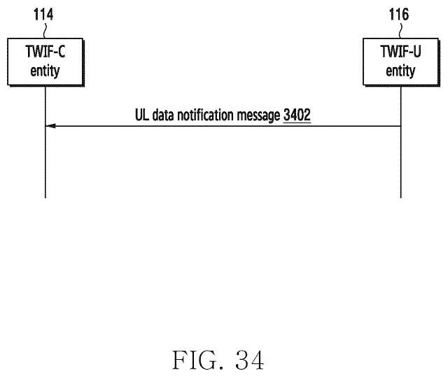

FIG. 34 is a signal flow diagram illustrating an example UL data notification procedure, according to various embodiments. As shown in FIG. 34, at step 3402, the TWIF-U entity (116) sends a UL data notification message to the TWIF-C entity (114). The UL data notification message (e.g., E13AP:UL DATA NOTIFICATION message or the like) is sent by the TWIF-U entity (116) to report data volumes. Information in the UL data notification message is shown in Table 49.

TABLE 49

| IE/Group Name | Presence | Range |
|---|---|---|
| Message Type | M | |
| TWIF-C UE | M | |
| E13AP ID | | |
| TWIF-U UE | M | |
| E13AP ID | | |
| PDU Session To | | 1 |
| Notify List | | |
| >PDU Session To | | 1 . . . <maxnoofPDUSessionResource> |
| Notify Item | | |
| >>PDU Session ID | M | |

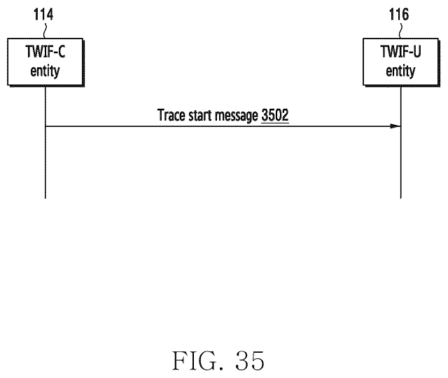

FIG. 35 is a signal flow diagram illustrating an example trace start procedure, according to various embodiments. As shown in FIG. 35, at step 3502, the TWIF-C entity (114) sends a trace start message (e.g., E13AP:TRACE START message or the like) to the TWIF-U entity (116). The trace start message is sent by the TWIF-C entity (114) to initiate a trace session for the UE. Information in the trace start message is shown in Table 50.

TABLE 50

| IE/Group Name | Presence |
|---|---|
| Message Type | M |
| TWIF-C UE E13AP ID | M |
| TWIF-U UE E13AP ID | M |
| Trace Activation | M |

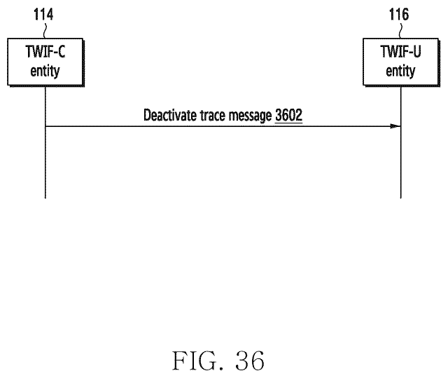

FIG. 36 is a signal flow diagram illustrating an example deactivate trace procedure, according to various embodiments. As shown in FIG. 36, at step 3602, the TWIF-C entity (114) sends a deactivate trace message (e.g., E13AP:DEACTIVATE TRACE message or the like) to the TWIF-U entity (116). The deactivate trace message is sent by the TWIF-C entity (114) to deactivate a trace session. Information in the deactivate trace message is shown in Table 51.

TABLE 51

| IE/Group Name | Presence |
|---|---|
| Message Type | M |
| TWIF-C UE E13AP ID | M |
| TWIF-U UE E13AP ID | M |
| Trace ID | M |

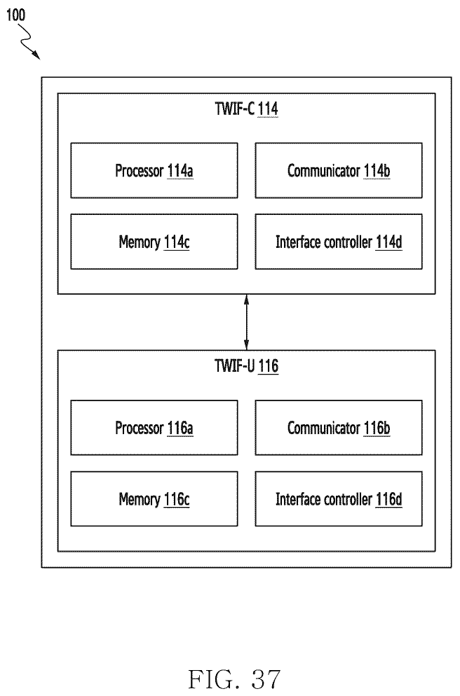

FIG. 37 is a block diagram illustrating an example configuration of the wireless network (100), according to various embodiments. In an embodiment, the wireless network (100) includes a TWIF-C entity (114) and a TWIF-U entity (116).

In an embodiment, the TWIF-C entity (114) includes a processor (e.g., including processing circuitry) (114a), a communicator (or a communication circuit) (e.g., including communication circuitry) (114b), a memory (114c), and an interface controller (e.g., including various circuitry) (114d). The processor (114a) is communicatively coupled with the communicator (114b), the memory (114c), and the interface controller (114d).

The interface controller (114d) may include various interface circuitry and splits the functionality of the TWIF into the control plane functionality, where the control plane functionality is handled by the TWIF-C entity (114). Further, the interface controller (114d) adds the interface between the TWIF-C entity (114) and the TWIF-U entity (116). Further, the interface controller (114d) monitors at least one of the operation associated with the interface and the service associated with the interface.

The interface controller (114d) may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (114a) may include various processing circuitry and is configured to execute instructions stored in the memory (114c) and to perform various processes. The communicator (114b) may include various communication circuitry and is configured for communicating internally between internal hardware components and with external devices via one or more networks. The memory (114c) stores instructions to be executed by the processor (114a). The memory (114c) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (114a) may, in some examples, be considered a non-transitory storage medium. The term “non-transitory” may indicate that the storage medium is not embodied in a carrier wave or a propagated signal. However, the term “non-transitory” should not be interpreted that the memory (114c) is non-movable. In certain examples, a non-transitory storage medium may store data that can, over time, change (e.g., in Random Access Memory (RAM) or cache). Further, the processor 114a according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment, the TWIF-U entity (116) includes a processor (e.g., including processing circuitry) (116a), a communicator (e.g., including processing circuitry) (116b), a memory (116c), and an interface controller (e.g., including various interface circuitry) (116d). The processor (116a) is communicatively coupled with the communicator (116b), the memory (116c), and the interface controller (116d).

The interface controller (116d) may include various interface circuitry and splits the functionality of the TWIF into the user plane functionality, where the user plane functionality is handled by the TWIF-U entity (116). Further, the interface controller (116d) adds an interface between the TWIF-C entity (114) and the TWIF-U entity (116). Further, the interface controller (116d) monitors at least one of the operation associated with the interface and the service associated with the interface.

The interface controller (116d) may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

The interface controller (114d or 116d) may include various interface control circuitry and monitors an operation associated with the interface and a service associated with the interface. The operation can be, for example, but not limited to the user plane traffic procedure, the interface management procedure, the bearer management procedure, the trace start procedure, the deactivate trace procedure, and the load management procedure. The service can be, for example, but not limited to a UE-associated service and a non UE-associated service.

The interface management procedure may be, for example, but not limited to, the reset procedure initiated from the TWIF-C entity (114), the reset procedure initiated from the at least one TWIF-U entity (116), the error indication procedure originated at the TWIF-C entity (114), the error indication procedure originated at the at least one TWIF-U entity (116), the TWIF-U E13 setup procedure, the TWIF-C E13 setup procedure, the TWIF-U configuration update procedure, the TWIF-C configuration update procedure, the E13 release procedure, and the TWIF-U status indication procedure.

The bearer management procedure can be, for example, but not limited to the bearer context setup procedure, the bearer context release request procedure initiated by the at least one TWIF-U entity (116), the bearer context release procedure initiated by the TWIF-C entity (114), the bearer context modification procedure initiated by the TWIF-C entity (114), the bearer context modification required procedure initiated by the at least one TWIF-U entity (116), the bearer context inactivity notification procedure, the data usage report procedure, the DL data notification procedure, and the UL data notification procedure. The load management procedure can be, for example, but not limited to a resource status reporting initiation procedure and a resource status reporting procedure.

The interface controller (116d) may be physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (116a) may include various processing circuitry and is configured to execute instructions stored in the memory (116c) and to perform various processes. The communicator (116b) may include various communication circuitry and is configured for communicating internally between internal hardware components and with external devices via one or more networks. The memory (116c) also stores instructions to be executed by the processor (116a). The memory (116c) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (116c) may, in some examples, be considered a non-transitory storage medium. The term “non-transitory” may indicate that the storage medium is not embodied in a carrier wave or a propagated signal. However, the term “non-transitory” should not be interpreted that the memory (116c) is non-movable. In certain examples, a non-transitory storage medium may store data that can, over time, change (e.g., in Random Access Memory (RAM) or cache). Further, the processor 116a according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Although FIG. 37 shows various hardware components of the wireless network (100) but it is to be understood that various embodiments are not limited thereon. In various embodiments, the wireless network (100) may include less or more number of components. Further, the labels or names of the components are used only for illustrative purpose and does not limit the scope of the disclosure. One or more components can be combined together to perform same or substantially similar function in the wireless network (100).

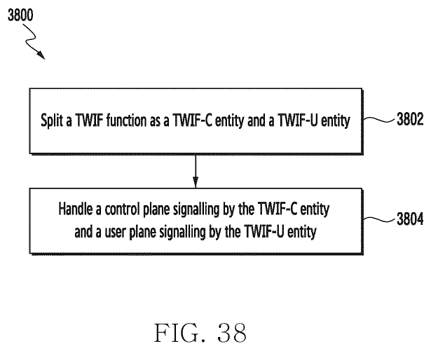

FIG. 38 is a flowchart (3800) illustrating an example method for managing the TWIF operation in a wireless network (100), according to various embodiments.

At step 3802, the method includes splitting the TWIF function as the TWIF-C entity (114) and the TWIF-U entity (116). At step 3804, the method includes handling the control plane signalling by the TWIF-C entity (114) and the user plane signalling by the TWIF-U entity (116).

The method can be implemented in the CUPS on TWIF by splitting TWIF into the TWIF-C entity (114) and the TWIF-U entity (116) and by introducing the interface (e.g., E13 interface) between the TWIF-C entity (114) and the TWIF-U entity (116).

According to embodiments, a method performed by a trusted wireless local area network (WLAN) Interworking Function (TWIF) control plane (TWIF-C) entity in a trusted WLAN access network, may comprise communicating with a TWIF user plane (TWIF-U) entity through a E13 interface. Each of the TWIF-C entity and the TWIF-U entity may be communicated with a trusted WLAN access point (TWAP) in the trusted WLAN access network connected to a user equipment (UE).

In an embodiment, the TWIF-C entity may handle a control plane signalling between the TWAP and an entity in a core network. The TWIF-U entity may handle a user plane signalling between the TWAP and another entity in the core network. The E13 interface between the TWIF-C entity and the TWIF-U entity may comprise an E13 Application Protocol (AP).

In an embodiment, the E13AP may be specific to the TWIF-C and the TWIF-U and is configured to run on one of a Stream Control Transmission Protocol (SCTP), a Transmission Control Protocol (TCP), and a User Datagram Protocol (UDP). The E13AP may be configured to support at least one of a UE-associated service and a non UE-associated service.

In an embodiment, the E13AP may be used to transmit or receive at least one interface management signalling message. The at least one interface management signalling message may comprise at least one of: an E13AP:RESET message, an E13AP:RESET ACKNOWLEDGE message, an E13AP:ERROR INDICATION message, an E13AP:TWIF-U E13 SETUP REQUEST message, an E13AP:TWIF-U E13 SETUP RESPONSE message, an E13AP:TWIF-U E13 SETUP FAILURE message, an E13AP:TWIF-CE13 SETUP REQUEST message, an E13AP:TWIF-C E13 SETUP RESPONSE message, an E13AP:TWIF-C E13 SETUP FAILURE message, an E13AP:TWIF-U CONFIGURATION UPDATE message, an E13AP:TWIF-U CONFIGURATION UPDATE ACKNOWLEDGE message, an E13AP:TWIF-U CONFIGURATION UPDATE FAILURE message, an E13AP:TWIF-C CONFIGURATION UPDATE message, an E13AP:TWIF-C CONFIGURATION UPDATE ACKNOWLEDGE message, an E13AP:TWIF-C CONFIGURATION UPDATE FAILURE message, an E13AP:E13 RELEASE REQUEST message, an E13AP:E13 RELEASE RESPONSE message, or an E13AP:TWIF-U STATUS INDICATION message.

In an embodiment, the E13AP may be used to transmit or receive at least one bearer management signalling message. The at least one bearer management signalling message may comprise at least one of: an E13AP:BEARER CONTEXT SETUP REQUEST message, an E13AP:BEARER CONTEXT SETUP RESPONSE message, an E13AP:BEARER CONTEXT SETUP FAILURE RESPONSE message, an E13AP:BEARER CONTEXT MODIFICATION REQUEST message, an E13AP:BEARER CONTEXT MODIFICATION RESPONSE message, an E13AP:BEARER CONTEXT MODIFICATION FAILURE message, an E13AP:BEARER CONTEXT MODIFICATION REQUIRED message, an E13AP:BEARER CONTEXT MODIFICATION CONFIRM message, an E13AP:BEARER CONTEXT RELEASE COMMAND message, an E13AP:BEARER CONTEXT RELEASE COMPLETE message, an E13AP:BEARER CONTEXT RELEASE REQUEST message, an E13AP:BEARER CONTEXT INACTIVITY NOTIFICATION message, an E13AP:DATA USAGE REPORT message, an E13AP:UL DATA NOTIFICATION message, or an E13AP:DL DATA NOTIFICATION message.

In an embodiment, the E13AP may be used to transmit or receive at least one UE Trace signalling message. The at least one UE Trace signalling message may comprise at least one of: an E13AP:TRACE START message or an E13AP:DEACTIVATE TRACE message.

In an embodiment, the E13AP may be used to transmit or receive at least one Load management signalling message. The at least one Load management signalling message may comprise at least one of: an E13AP:RESOURCE STATUS REQUEST message, an E13AP:RESOURCE STATUS RESPONSE message, an E13AP:RESOURCE STATUS FAILURE message, or an E13AP:RESOURCE STATUS UPDATE message.

In an embodiment, the entity may comprise an access and mobility management function (AMF) through an N1 interface or an N2 interface. The other entity may comprise a user plane function, through an N3 interface, connected to a data network.

In an embodiment, the TWIF-C entity may be configured to select the TWIF-U entity during a protocol data unit (PDU) session establishment procedure based on a local selection procedure.

In an embodiment, the TWIF-C may be configured to move a UE context from the TWIF-U to another TWIF-U during at least one failure procedure.

According to embodiments, a method performed by a trusted wireless local area network (WLAN) Interworking Function (TWIF) user plane (TWIF-U) entity in a trusted WLAN access network, may comprise communicating with a TWIF control plane (TWIF-C) entity through a E13 interface. Each of the TWIF-C entity and the TWIF-U entity may be communicated with a trusted WLAN access point (TWAP) in the trusted WLAN access network connected to a user equipment (UE).

In an embodiment, the TWIF-C entity may handle a control plane signalling between the TWAP and an entity in a core network. The TWIF-U entity may handle a user plane signalling between the TWAP and another entity in the core network. The E13 interface between the TWIF-C entity and the TWIF-U entity may comprise an E13 Application Protocol (AP).

In an embodiment, the E13AP may be specific to the TWIF-C and the TWIF-U and is configured to run on one of a Stream Control Transmission Protocol (SCTP), a Transmission Control Protocol (TCP), and a User Datagram Protocol (UDP). The E13AP may be configured to support at least one of a UE-associated service and a non UE-associated service.

In an embodiment, the E13AP may be used to transmit or receive at least one interface management signalling message. The at least one interface management signalling message may comprise at least one of: an E13AP:RESET message, an E13AP:RESET ACKNOWLEDGE message, an E13AP:ERROR INDICATION message, an E13AP:TWIF-U E13 SETUP REQUEST message, an E13AP:TWIF-U E13 SETUP RESPONSE message, an E13AP:TWIF-U E13 SETUP FAILURE message, an E13AP:TWIF-C E13 SETUP REQUEST message, an E13AP:TWIF-C E13 SETUP RESPONSE message, an E13AP:TWIF-C E13 SETUP FAILURE message, an E13AP:TWIF-U CONFIGURATION UPDATE message, an E13AP:TWIF-U CONFIGURATION UPDATE ACKNOWLEDGE message, an E13AP:TWIF-U CONFIGURATION UPDATE FAILURE message, an E13AP:TWIF-C CONFIGURATION UPDATE message, an E13AP:TWIF-C CONFIGURATION UPDATE ACKNOWLEDGE message, an E13AP:TWIF-C CONFIGURATION UPDATE FAILURE message, an E13AP:E13 RELEASE REQUEST message, an E13AP:E13 RELEASE RESPONSE message, or an E13AP:TWIF-U STATUS INDICATION message.

In an embodiment, the E13AP may be used to transmit or receive at least one bearer management signalling message. The at least one bearer management signalling message may comprise at least one of: an E13AP:BEARER CONTEXT SETUP REQUEST message, an E13AP:BEARER CONTEXT SETUP RESPONSE message, an E13AP:BEARER CONTEXT SETUP FAILURE RESPONSE message, an E13AP:BEARER CONTEXT MODIFICATION REQUEST message, an E13AP:BEARER CONTEXT MODIFICATION RESPONSE message, an E13AP:BEARER CONTEXT MODIFICATION FAILURE message, an E13AP:BEARER CONTEXT MODIFICATION REQUIRED message, an E13AP:BEARER CONTEXT MODIFICATION CONFIRM message, an E13AP:BEARER CONTEXT RELEASE COMMAND message, an E13AP:BEARER CONTEXT RELEASE COMPLETE message, an E13AP:BEARER CONTEXT RELEASE REQUEST message, an E13AP:BEARER CONTEXT INACTIVITY NOTIFICATION message, an E13AP:DATA USAGE REPORT message, an E13AP:UL DATA NOTIFICATION message, or an E13AP:DL DATA NOTIFICATION message.

In an embodiment, the E13AP may be used to transmit or receive at least one UE Trace signalling message. The at least one UE Trace signalling message may comprise at least one of: an E13AP:TRACE START message or an E13AP:DEACTIVATE TRACE message.

In an embodiment, the E13AP may be used to transmit or receive at least one Load management signalling message. The at least one Load management signalling message may comprise at least one of: an E13AP:RESOURCE STATUS REQUEST message, an E13AP:RESOURCE STATUS RESPONSE message, an E13AP:RESOURCE STATUS FAILURE message, or an E13AP:RESOURCE STATUS UPDATE message.

In an embodiment, the entity may comprise an access and mobility management function (AMF) through an N1 interface or an N2 interface. The other entity may comprise a user plane function, through an N3 interface, connected to a data network.

According to embodiments, a TWIF Control plane (TWIF-C) entity may comprise at least one processor. The TWIF-C entity may comprise memory storing instructions. The instructions, when executed by the at least one processor, may cause the TWIF-C entity to communicate with a TWIF user plane (TWIF-U) entity through a E13 interface. Each of the TWIF-C entity and the TWIF-U entity may be communicated with a trusted WLAN access point (TWAP) in the trusted WLAN access network connected to a user equipment (UE).

In an embodiment, the TWIF-C entity may handle a control plane signalling between the TWAP and an entity in a core network. The TWIF-U entity may handle a user plane signalling between the TWAP and another entity in the core network. The E13 interface between the TWIF-C entity and the TWIF-U entity may comprise an E13 Application Protocol (AP).

According to embodiments, a non-transitory computer readable storage medium, when individually or collectively executed by at least one processor of a TWIF Control plane (TWIF-C) entity, may store one or more computer programs including instructions that cause the TWIF-C entity to communicate with a TWIF user plane (TWIF-U) entity through a E13 interface. Each of the TWIF-C entity and the TWIF-U entity may be communicated with a trusted WLAN access point (TWAP) in the trusted WLAN access network connected to a user equipment (UE).

According to embodiments, a TWIF user plane (TWIF-U) entity may comprise at least one processor. The TWIF-U entity may comprise memory storing instructions. The instructions, when executed by the at least one processor, may cause the TWIF-U entity to communicate with a TWIF control plane (TWIF-C) entity through a E13 interface. Each of the TWIF-C entity and the TWIF-U entity may be communicated with a trusted WLAN access point (TWAP) in the trusted WLAN access network connected to a user equipment (UE).

According to embodiments, a non-transitory computer readable storage medium, when individually or collectively executed by at least one processor of a TWIF user plane (TWIF-U) entity, may store one or more computer programs including instructions that cause the TWIF-U entity to communicate with a TWIF control plane (TWIF-C) entity through a E13 interface. Each of the TWIF-C entity and the TWIF-U entity may be communicated with a trusted WLAN access point (TWAP) in the trusted WLAN access network connected to a user equipment (UE).

According to embodiments, a method for managing a Trusted WLAN Interworking Function (TWIF) operation in a wireless network, may comprise splitting a TWIF function as a TWIF Control plane (TWIF-C) entity and a TWIF User plane (TWIF-U) entity. The method may comprise handling a control plane signalling by the TWIF-C entity and a user plane signalling by the TWIF-U entity.

In an embodiment, the method may further comprise creating an E13 interface between the TWIF-C entity and the TWIF-U entity wherein the E13 interface comprises an E13 Application Protocol (AP).

In an embodiment, the E13AP may be specific to the TWIF-C and TWIF-U and may be configured to run on one of a Stream Control Transmission Protocol (SCTP), a Transmission Control Protocol (TCP), and a User Datagram Protocol (UDP), and wherein the E13AP is configured to support at least one of a user equipment (UE)-associated service and a non UE-associated service.

In an embodiment, the E13AP may be configured to support at least one interface management signalling message. The at least one interface management signalling message may comprise at least one of: an E13AP:RESET message, an E13AP:RESET ACKNOWLEDGE message, an E13AP:ERROR INDICATION message, an E13AP:TWIF-U E13 SETUP REQUEST message, an E13AP:TWIF-U E13 SETUP RESPONSE message, an E13AP:TWIF-U E13 SETUP FAILURE message, an E13AP:TWIF-CE13 SETUP REQUEST message, an E13AP:TWIF-C E13 SETUP RESPONSE message, an E13AP:TWIF-C E13 SETUP FAILURE message, an E13AP:TWIF-U CONFIGURATION UPDATE message, an E13AP:TWIF-U CONFIGURATION UPDATE ACKNOWLEDGE message, an E13AP:TWIF-U CONFIGURATION UPDATE FAILURE message, an E13AP:TWIF-C CONFIGURATION UPDATE message, an E13AP:TWIF-C CONFIGURATION UPDATE ACKNOWLEDGE message, an E13AP:TWIF-C CONFIGURATION UPDATE FAILURE message, an E13AP:E13 RELEASE REQUEST message, an E13AP:E13 RELEASE RESPONSE message and an E13AP:TWIF-U STATUS INDICATION message.

In an embodiment, the E13AP may be configured to support at least one bearer management signalling message. The at least one bearer management signalling message may comprise at least one of: an E13AP:BEARER CONTEXT SETUP REQUEST message, an E13AP:BEARER CONTEXT SETUP RESPONSE message, an E13AP:BEARER CONTEXT SETUP FAILURE RESPONSE message, an E13AP:BEARER CONTEXT MODIFICATION REQUEST message, an E13AP:BEARER CONTEXT MODIFICATION RESPONSE message, an E13AP:BEARER CONTEXT MODIFICATION FAILURE message, an E13AP:BEARER CONTEXT MODIFICATION REQUIRED message, an E13AP:BEARER CONTEXT MODIFICATION CONFIRM message, an E13AP:BEARER CONTEXT RELEASE COMMAND message, an E13AP:BEARER CONTEXT RELEASE COMPLETE message, an E13AP:BEARER CONTEXT RELEASE REQUEST message, an E13AP:BEARER CONTEXT INACTIVITY NOTIFICATION message, an E13AP:DATA USAGE REPORT message, an E13AP:UL DATA NOTIFICATION message, and an E13AP:DL DATA NOTIFICATION message.

In an embodiment, the E13AP may be configured to support at least one user equipment (UE) Trace signalling message. The at least one UE Trace signalling message may comprise at least one of: an E13AP:TRACE START message and an E13AP:DEACTIVATE TRACE message.

In an embodiment, the E13AP may be configured to support at least one Load management signalling message. The at least one Load management signalling message may comprise at least one of: an E13AP:RESOURCE STATUS REQUEST message, an E13AP:RESOURCE STATUS RESPONSE message, an E13AP:RESOURCE STATUS FAILURE message and an E13AP:RESOURCE STATUS UPDATE message.

In an embodiment, at least one control plane functionality from a User Equipment (UE) towards a core network may pass through the TWIF-C entity.

In an embodiment, at least one user plane functionality may pass from a user equipment (UE) towards a data network through the at least one TWIF-U entity.

In an embodiment, the TWIF-C entity may be configured to select the at least one TWIF-U entity during a protocol data unit (PDU) session establishment procedure based on a local selection procedure.

In an embodiment, the TWIF-C may be configured to move a (UE) context from one TWIF-U to another TWIF-U during at least one failure scenario.

According to embodiments, a TWIF Control plane (TWIF-C) entity may comprise at least one processor, comprising processing circuitry. The TWIF-C entity may comprise a memory. The TWIF-C entity may comprise an interface controller, comprising circuitry, coupled with at least one processor and the memory. The interface controller may be configured to support control plane functionality, wherein the control plane functionality is handled by the TWIF-C entity. The interface controller may be configured to add an E13 interface between the TWIF-C entity and at least one TWIF User Plane (TWIF-U) entity. The interface controller may be configured to monitor at least one of an operation associated with the E13 interface and a service associated with the E13 interface.

According to embodiments, a TWIF user plane (TWIF-U) entity may comprise at least one processor, comprising processing circuitry. The TWIF-U entity may comprise a memory. The TWIF-U entity may comprise an interface controller, comprising circuitry, coupled with at least one processor and the memory. The interface controller may be configured to support a user plane functionality, wherein the user plane functionality is handled by the TWIF-U entity. The interface controller may be configured to add an E13 interface between a TWIF Control plane (TWIF-C) entity and the TWIF-U entity. The interface controller may be configured to monitor at least one of an operation associated with the E13 interface and a service associated with the E13 interface.

The various actions, acts, blocks, steps, or the like in the flowchart (3800) may be performed in the order presented, in a different order or simultaneously. Further, in various embodiments, some of the actions, acts, blocks, steps, or the like may be omitted, added, modified, skipped, or the like without departing from the scope of the disclosure.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

No claim element is to be construed under the provisions of 35 U.S.C. § 112, sixth paragraph, unless the element is expressly recited using the phrase “means for” or “means”.

What is claimed is:

1. A method performed by a trusted wireless local area network (WLAN) Interworking Function (TWIF) control plane (TWIF-C) entity in a trusted WLAN access network, comprising:
communicating with a TWIF user plane (TWIF-U) entity through a E13 interface,
wherein each of the TWIF-C entity and the TWIF-U entity is communicated with a trusted WLAN access point (TWAP) in the trusted WLAN access network connected to a user equipment (UE).

2. The method of claim 1, wherein the TWIF-C entity handles a control plane signalling between the TWAP and an entity in a core network,
wherein the TWIF-U entity handles a user plane signalling between the TWAP and another entity in the core network, and
wherein the E13 interface between the TWIF-C entity and the TWIF-U entity comprises an E13 Application Protocol (AP).

3. The method of claim 2, wherein the E13AP is specific to the TWIF-C and the TWIF-U and is configured to run on one of a Stream Control Transmission Protocol (SCTP), a Transmission Control Protocol (TCP), and a User Datagram Protocol (UDP), and
wherein the E13AP is configured to support at least one of a UE-associated service or a non UE-associated service.

4. The method of claim 2, wherein the E13AP is used to transmit or receive at least one interface management signalling message, and
wherein the at least one interface management signalling message comprises at least one of: an E13AP:RESET message, an E13AP:RESET ACKNOWLEDGE message, an E13AP:ERROR INDICATION message, an E13AP:TWIF-U E13 SETUP REQUEST message, an E13AP:TWIF-U E13 SETUP RESPONSE message, an E13AP:TWIF-U E13 SETUP FAILURE message, an E13AP:TWIF-C E13 SETUP REQUEST message, an E13AP:TWIF-C E13 SETUP RESPONSE message, an E13AP:TWIF-C E13 SETUP FAILURE message, an E13AP:TWIF-U CONFIGURATION UPDATE message, an E13AP:TWIF-U CONFIGURATION UPDATE ACKNOWLEDGE message, an E13AP:TWIF-U CONFIGURATION UPDATE FAILURE message, an E13AP:TWIF-C CONFIGURATION UPDATE message, an E13AP:TWIF-C CONFIGURATION UPDATE ACKNOWLEDGE message, an E13AP:TWIF-C CONFIGURATION UPDATE FAILURE message, an E13AP:E13 RELEASE REQUEST message, an E13AP:E13 RELEASE RESPONSE message, or an E13AP:TWIF-U STATUS INDICATION message.

5. The method of claim 2, wherein the E13AP is used to transmit or receive at least one bearer management signalling message, and
wherein the at least one bearer management signalling message comprises at least one of: an E13AP:BEARER CONTEXT SETUP REQUEST message, an E13AP:BEARER CONTEXT SETUP RESPONSE message, an E13AP:BEARER CONTEXT SETUP FAILURE RESPONSE message, an E13AP:BEARER CONTEXT MODIFICATION REQUEST message, an E13AP:BEARER CONTEXT MODIFICATION RESPONSE message, an E13AP:BEARER CONTEXT MODIFICATION FAILURE message, an E13AP:BEARER CONTEXT MODIFICATION REQUIRED message, an E13AP:BEARER CONTEXT MODIFICATION CONFIRM message, an E13AP:BEARER CONTEXT RELEASE COMMAND message, an E13AP:BEARER CONTEXT RELEASE COMPLETE message, an E13AP:BEARER CONTEXT RELEASE REQUEST message, an E13AP:BEARER CONTEXT INACTIVITY NOTIFICATION message, an E13AP:DATA USAGE REPORT message, an E13AP:UL DATA NOTIFICATION message, or an E13AP:DL DATA NOTIFICATION message.

6. The method of claim 2, wherein the E13AP is used to transmit or receive at least one UE Trace signalling message, and
wherein the at least one UE Trace signalling message comprises at least one of: an E13AP:TRACE START message or an E13AP:DEACTIVATE TRACE message.

7. The method of claim 2, wherein the E13AP is used to transmit or receive at least one Load management signalling message, and
wherein the at least one Load management signalling message comprises at least one of: an E13AP:RESOURCE STATUS REQUEST message, an E13AP:RESOURCE STATUS RESPONSE message, an E13AP:RESOURCE STATUS FAILURE message, or an E13AP:RESOURCE STATUS UPDATE message.

8. The method of claim 2, wherein the entity comprises an access and mobility management function (AMF) through an N1 interface or an N2 interface, and
wherein the other entity comprises a user plane function, through an N3 interface, connected to a data network.

9. The method of claim 1, wherein the TWIF-C entity is configured to select the TWIF-U entity during a protocol data unit (PDU) session establishment procedure based on a local selection procedure.

10. The method of claim 1, wherein the TWIF-C is configured to move a UE context from the TWIF-U to another TWIF-U during at least one failure procedure.

11. A method performed by a trusted wireless local area network (WLAN) Interworking Function (TWIF) user plane (TWIF-U) entity in a trusted WLAN access network, comprising:
communicating with a TWIF control plane (TWIF-C) entity through a E13 interface,
wherein each of the TWIF-C entity and the TWIF-U entity is communicated with a trusted WLAN access point (TWAP) in the trusted WLAN access network connected to a user equipment (UE).

12. The method of claim 11, wherein the TWIF-C entity handles a control plane signalling between the TWAP and an entity in a core network,
wherein the TWIF-U entity handles a user plane signalling between the TWAP and another entity in the core network, and
wherein the E13 interface between the TWIF-C entity and the TWIF-U entity comprises an E13 Application Protocol (AP).

13. The method of claim 12, wherein the E13AP is specific to the TWIF-C and the TWIF-U and is configured to run on one of a Stream Control Transmission Protocol (SCTP), a Transmission Control Protocol (TCP), and a User Datagram Protocol (UDP), and
wherein the E13AP is configured to support at least one of a UE-associated service and a non UE-associated service.

14. The method of claim 12, wherein the E13AP is used to transmit or receive at least one interface management signalling message, and
wherein the at least one interface management signalling message comprises at least one of: an E13AP:RESET message, an E13AP:RESET ACKNOWLEDGE message, an E13AP:ERROR INDICATION message, an E13AP:TWIF-U E13 SETUP REQUEST message, an E13AP:TWIF-U E13 SETUP RESPONSE message, an E13AP:TWIF-U E13 SETUP FAILURE message, an E13AP:TWIF-C E13 SETUP REQUEST message, an E13AP:TWIF-C E13 SETUP RESPONSE message, an E13AP:TWIF-C E13 SETUP FAILURE message, an E13AP:TWIF-U CONFIGURATION UPDATE message, an E13AP:TWIF-U CONFIGURATION UPDATE ACKNOWLEDGE message, an E13AP:TWIF-U CONFIGURATION UPDATE FAILURE message, an E13AP:TWIF-C CONFIGURATION UPDATE message, an E13AP:TWIF-C CONFIGURATION UPDATE ACKNOWLEDGE message, an E13AP:TWIF-C CONFIGURATION UPDATE FAILURE message, an E13AP:E13 RELEASE REQUEST message, an E13AP:E13 RELEASE RESPONSE message, or an E13AP:TWIF-U STATUS INDICATION message.

15. The method of claim 12, wherein the E13AP is used to transmit or receive at least one bearer management signalling message, and
wherein the at least one bearer management signalling message comprises at least one of: an E13AP:BEARER CONTEXT SETUP REQUEST message, an E13AP:BEARER CONTEXT SETUP RESPONSE message, an E13AP:BEARER CONTEXT SETUP FAILURE RESPONSE message, an E13AP:BEARER CONTEXT MODIFICATION REQUEST message, an E13AP:BEARER CONTEXT MODIFICATION RESPONSE message, an E13AP:BEARER CONTEXT MODIFICATION FAILURE message, an E13AP:BEARER CONTEXT MODIFICATION REQUIRED message, an E13AP:BEARER CONTEXT MODIFICATION CONFIRM message, an E13AP:BEARER CONTEXT RELEASE COMMAND message, an E13AP:BEARER CONTEXT RELEASE COMPLETE message, an E13AP:BEARER CONTEXT RELEASE REQUEST message, an E13AP:BEARER CONTEXT INACTIVITY NOTIFICATION message, an E13AP:DATA USAGE REPORT message, an E13AP:UL DATA NOTIFICATION message, or an E13AP:DL DATA NOTIFICATION message.

16. The method of claim 12, wherein the E13AP is used to transmit or receive at least one UE Trace signalling message, and
wherein the at least one UE Trace signalling message comprises at least one of: an E13AP:TRACE START message or an E13AP:DEACTIVATE TRACE message.

17. The method of claim 12, wherein the E13AP is used to transmit or receive at least one Load management signalling message, and
wherein the at least one Load management signalling message comprises at least one of: an E13AP:RESOURCE STATUS REQUEST message, an E13AP:RESOURCE STATUS RESPONSE message, an E13AP:RESOURCE STATUS FAILURE message, or an E13AP:RESOURCE STATUS UPDATE message.

18. The method of claim 12, wherein the entity comprises an access and mobility management function (AMF) through an N1 interface or an N2 interface, and
wherein the other entity comprises a user plane function, through an N3 interface, connected to a data network.

19. A TWIF Control plane (TWIF-C) entity, comprising:
at least one processor; and
memory storing instructions; and
wherein the instructions, when executed by the at least one processor, cause the TWIF-C entity to:
communicate with a TWIF user plane (TWIF-U) entity through a E13 interface,
wherein each of the TWIF-C entity and the TWIF-U entity is communicated with a trusted WLAN access point (TWAP) in the trusted WLAN access network connected to a user equipment (UE).

20. The TWIF-C of claim 19, wherein the TWIF-C entity handles a control plane signalling between the TWAP and an entity in a core network,
wherein the TWIF-U entity handles a user plane signalling between the TWAP and another entity in the core network, and
wherein the E13 interface between the TWIF-C entity and the TWIF-U entity comprises an E13 Application Protocol (AP).
